(19) United States
(12) Patent Application Publication
(10) Pub. No.: US 2012/0212807 A1
(43) Pub. Date: Aug. 23, 2012

(54) Infrared Lens

(75) Inventor: Kouji Kawaguchi, Saitama-shi (JP)

(73) Assignee: Tamron Co., Ltd., Saitama-shi (JP)

(21) Appl. No.: 13/402,742

(22) Filed: Feb. 22, 2012

(30) Foreign Application Priority Data
Feb. 22, 2011 (JP) 2011-036226
Feb. 22, 2011 (JP) 2011-036227
Feb. 22, 2011 (JP) 2011-036228

(51) Int. Cl. G02B 13/14

(52) U.S. Cl. 359/356

(57) ABSTRACT

An infrared lens has three lens groups put in serial order from a position closer to an object, namely, the foremost or first group of lens pieces of positive refractivity, the succeeding or second group of lens pieces of negative refractivity, and the rearmost or third group of lens pieces of positive refractivity, and a substance of the second group of lens pieces having greater dispersive power than that or those of the first and third groups of lens pieces. The infrared lens assuredly retains sufficient brightness, namely, having an appropriate numerical aperture, but yet no longer suffers chromatic aberration for rays in a wavelength range of 10 μm or so in addition to fully correcting spherical aberration, comatic aberration, and curvature of field, thereby attaining clear and vivid focused images.

### FIELD OF THE INVENTION

The present invention relates to an infrared lens, and more particularly, to an infrared lens adapted to form a clear image by focusing infrared rays so as to be suitable for applications of infrared ray thermography, surveillance cameras, and the like. The term ‘infrared rays’ used herein refers to radiations including intermediate infrared rays of wavelength ranging from 3000 to 5000 nm and far infrared rays ranging from 8000 to 14000 nm.

### BACKGROUND ART

Medical-purpose or industrial IR sensors and vidicons for transmitted light of wavelength around approximately 10 micrometers are dull in light sensitivity. Germanium used in their optics has a poorer transmissivity than any other substances used in ordinary optical lenses. Thus, optics for such optical pickup devices are required to be a so-called ‘bright optics’ having a reduced aperture ratio.

One example of the prior art IR lens disclosed so far (see Patent Document 1 listed below) is comprised of three lens groups each of which consists of a single lens piece, including the foremost or first lens, closer to an object, that is a convex meniscus lens with its convex surface faced toward an object, the succeeding or second lens that is a concave lens, and the rearmost or third lens that is a convex meniscus lens with its concave surface faced toward an object; and such an IR lens meets requirements as defined in the following formulae:

0.79≦f/f1<0.87 (1)

−0.43≦(r1+r5)/r3≦0.076 (2)

0.151f≦(d1+d3+d5)≦0.176f (3)

where f is a focal length of the entire optics, f1 is the focal length of the first lens, ri is a radius of curvature of the i-th lens surface that is the i-th closest to the object, and di is a distance between the opposite surfaces of the i-th lens or its thickness.

Another example of the prior art IR lens (see Patent Document 2 listed below) is comprised of two meniscus lens pieces and meets predetermined requirements as defined in a formula so as to reduce cost and weight and attain imaging performance satisfactory in practical use although compact as well. Specifically, such an IR lens consists of a first lens L1 that is a meniscus lens of positive refractive power with its convex surface faced to the object and a second lens L2. Also, the IR lens meets requirements defined in the following formulae (4) to (7):

0.8<R_{1 Convex}/f<3.0 (4)

0.3<R_{2 Convex}/f<1.2 (5)

0.8<D/f<1.4 (6)

N₁>2.0, N2>2.0 (7)

where f is a focal length of the entire optics, R1 Convex is a radius of curvature of a convex surface of the first lens L1, R2 Convex is the radius of curvature of the convex surface of the second lens L2, D is a distance between the first and second lenses, N1 is a refractive index of the first lens L1, and N2 is the refractive index of the second lens L2; and both the lenses L1 and L2 are made of germanium.

Still another example of the prior art IR lens is disclosed as that which can be fabricated at a reduced cost and designed to have a wider angle of view up to approximately 30 degrees and a sufficient back focus ensured relative to a focal length, still implementing a good optical performance for beams of wavelength band ranging from 7 μm to 1 μm. Such an IR lens is comprised of the foremost or first lens L1 that is located closer to an object than the remaining and is shaped in positive meniscus with its convex surface faced toward the object, an aperture stop, the succeeding or second lens L2 that is shaped in negative meniscus with its concave surface faced toward the object, and the rearmost or third lens L3 that is shaped in positive meniscus with its convex surface faced toward the object. Assuming now that the entire optics has a focal length as denoted by f, a fore surface of the second lens L2 closer to the object has a radius of curvature as denoted by r4, a hind surface of the second lens L2 closer to an imaging plate has the radius of curvature as denoted by r5, and the second lens L2 has a thickness at its center as designated by d4, the IR lens meets requirements defined in the following formulae (8) and (9):

0.4<|r4|/f<0.82 (8)

0.9<(|r4|+d4)/|r5|<1.10 (9)

(e.g., see Patent Document 3 listed below).

### CITED DOCUMENTS OF THE RELATED ART

### Patent Document 1

Official Gazette of Japanese Preliminary Publication of Unexamined Patent Application No. SH062-30208

### Patent Document 2

Official Gazette of Japanese Preliminary Publication of Unexamined Patent Application No. 2000-75203

### Patent Document 3

Official Gazette of Japanese Preliminary Publication of Unexamined Patent Application No. 2010-39243

### SUMMARY OF THE INVENTION

### Problem to be Solved by the Invention

The IR lens described in Patent Document 1 still suffers chromatic aberration for rays of wavelength of approximately 10 μm and fails to fully correct spherical aberration and field curvature. In addition, because of its poor resolving power, the IR lens cannot produce clear and vivid focused images.

The IR lens in Patent Document 2 still suffers chromatic aberration for rays of wavelength of approximately 10 μm and fails to fully correct spherical aberration and field curvature. In addition, because of its extended overall length of the optics, the IR lens design is not suitable for downsizing.

Since the IR lens disclosed in Patent Document 3 has its second and third lenses L2 and L3 arranged in a tight series with a small distance therebetween despite a great refractive power of the third lens L3, it necessitates a correspondingly extended back focus, and resultantly, insufficient compensation for astigmatism is unavoidable. Specifically, the IR lens in Patent Document 3 is devised to make a difference especially in attaining a wider angle of view, and hence, it can address correction of aberrations almost up to the standard for the wide-angle view. Meanwhile, for the telephoto view, the IR lens gets significantly long in its entire longitudinal dimension as well as in back focus without sufficient compensation for aberration, which would make users evaluate the IR lens as clumsy. Theses disadvantages of the IR lens in Patent Document 3 are more conspicuous when it focuses far infrared rays.

(1) The present invention is made to overcome the aforementioned disadvantages in the prior art IR lens, and accordingly, it is an object of the present invention to provide an infrared lens that assuredly retains sufficient brightness, namely, having an appropriate numerical aperture, but yet no longer suffers chromatic aberration for rays in a wavelength range of 10 μm or so in addition to fully correcting spherical aberration, comatic aberration, and curvature of field, thereby attaining clear and vivid focused images.

(2) It is another object of the present invention to provide an IR lens that is capable of acceptably compensating for comatic aberration throughout a zooming range from the telephoto view to the wide-angle view without further extending a longitudinal dimension of the IR lens in zooming out for the telephoto view as well as a back focus.

(3) A yet another object of the present invention is to provide a pliant infrared lens of three-lens group structure in which the second foremost lens group and the rearmost or third lens group are arranged in series with a greater distance therebetween, so as to have a shortened back focus and facilitate fully correcting astigmatism throughout the entire range from the telephoto view to the wide-angle view. Especially, in focusing far infrared rays of light, the IR lens of the present invention is intended to acceptably correct astigmatism throughout the entire range from the telephoto view to the wide-angle view, and to create images in the telephoto view without further extending a longitudinal dimension of the IR lens as well as a back focus.

### SUMMARY OF THE INVENTION

In a first aspect of the present invention, an infrared lens has three lens groups put in serial order from a position closer to an object, namely, the foremost or first group of lens pieces of positive refractivity, the succeeding or second group of lens pieces of negative refractivity, and the rearmost or third group of lens pieces of positive refractivity, and a substance of the second group of lens pieces has greater dispersive power than that or those of the first and third groups of lens pieces.

Refractive index of germanium relative to varied wavelength of transmitted light is 4.0074 to n(8 μm), 4.0052 to n(10 μm), and 4.0039 to n(12μ), respectively. An arithmetic operation based on the following formula of dispersion power, [n(8 μm)−n(12 μm)]/[n(10 μm)−1], brings about a resolution 0.0012 indicating the dispersive power of germanium.

Refractive index of zinc selenide relative to varied wavelength of transmitted light is 2.5917 to n(8 μm), 2.5861 to n(10 μm), and 2.5794 to n(12μ), respectively. Another arithmetic operation based on the same formula of dispersion power, [n(8 μm)−n(12 μm)]/[n(10 μm)−1], brings about a resolution 0.0078 indicating the dispersive power of chalcogenide.

Refractive index of zinc selenide relative to varied wavelength of transmitted light is 2.4163 to n(8 μm), 2.4053 to n(10 μm), and 2.3915 to n(12μ), respectively. Further another arithmetic operation based on the same formula of dispersion power, [n(8 μm)−n(12 μm)]/[n(10 μm)−1], brings about a resolution 0.0176 indicating the dispersive power of zinc selenide.

In a second aspect of the present invention, an infrared lens has three lens groups put in serial order from a position closer to an object, namely, the foremost or first group of lens pieces of positive refractivity, the succeeding or second group of lens pieces of negative refractivity, and the rearmost or third group of lens pieces of positive refractivity.

In a third aspect of the present invention, an infrared lens has three lens groups put in serial order from a position closer to an object, namely, the foremost or first group of lens pieces of positive refractivity, the succeeding or second group of lens pieces of positive refractivity, and the rearmost or third group of lens pieces of positive refractivity.

The infrared lens in the first aspect of the present invention is adapted to assuredly retain sufficient brightness, namely, having an appropriate numerical aperture, but yet no longer suffer chromatic aberration for rays in a wavelength range of 10 μm or so in addition to fully correcting spherical aberration, comatic aberration, and curvature of field, thereby attaining clear and vivid focused images.

The infrared lens in the second aspect of the present invention is adapted to assuredly retain sufficient brightness, namely, having an appropriate numerical aperture, and acceptably compensate for comatic aberration throughout a zooming range from the telephoto view to the wide-angle view without further extending a longitudinal dimension of the IR lens in zooming out for the telephoto view as well as its back focus.

The present invention in the third aspect provides a pliant infrared lens that is adapted to assuredly retain sufficient brightness, namely, having an appropriate numerical aperture, and has its second and third lens groups arranged in series with a greater distance therebetween, so as to have a shortened back focus and facilitate fully correcting astigmatism throughout a zooming range from the telephoto view to the wide-angle view. Especially, in focusing far infrared rays of light, the IR lens of the present invention in the third aspect can acceptably correct astigmatism throughout the entire range from the telephoto view to the wide-angle view, and to create images in the telephoto view without further extending a longitudinal dimension of the IR lens as well as its back focus.

### BRIEF DESCRIPTION OF THE DRAWINGS

FIG. 1 is a sectional view of optics of a first embodiment of an infrared lens in accordance with a first aspect of the present invention;

FIG. 2 is a graph illustrating spherical aberration observed in the first embodiment of the infrared lens according to the first aspect of the present invention;

FIG. 3 is a graph illustrating astigmatism observed in the first embodiment of the infrared lens according to the first aspect of the present invention;

FIG. 4 is a graph illustrating meridional comatic aberration observed in the first embodiment of the infrared lens according to the first aspect of the present invention;

FIG. 5 is a graph illustrating sagittal comatic aberration observed in the first embodiment of the infrared lens according to the first aspect of the present invention;

FIG. 6 is a sectional view of optics of a second embodiment of the infrared lens in accordance with the first aspect of the present invention;

FIG. 7 is a graph illustrating spherical aberration observed in the second embodiment of the infrared lens according to the first aspect of the present invention;

FIG. 8 is a graph illustrating astigmatism observed in the second embodiment of the infrared lens according to the first aspect of the present invention;

FIG. 9 is a graph illustrating meridional comatic aberration observed in the second embodiment of the infrared lens according to the first aspect of the present invention;

FIG. 10 is a graph illustrating sagittal comatic aberration observed in the second embodiment of the infrared lens according to the first aspect of the present invention;

FIG. 11 is a sectional view of optics of a third embodiment of an infrared lens in accordance with a first aspect of the present invention;

FIG. 12 is a graph illustrating spherical aberration observed in the third embodiment of the infrared lens according to the first aspect of the present invention;

FIG. 13 is a graph illustrating astigmatism observed in the third embodiment of the infrared lens according to the first aspect of the present invention;

FIG. 14 is a graph illustrating meridional comatic aberration observed in the third embodiment of the infrared lens according to the first aspect of the present invention;

FIG. 15 is a graph illustrating sagittal comatic aberration observed in the third embodiment of the infrared lens according to the first aspect of the present invention;

FIG. 16 is a sectional view of optics of a fourth embodiment of an infrared lens in accordance with a first aspect of the present invention;

FIG. 17 is a graph illustrating spherical aberration observed in the fourth embodiment of the infrared lens according to the first aspect of the present invention;

FIG. 18 is a graph illustrating astigmatism observed in the fourth embodiment of the infrared lens according to the first aspect of the present invention;

FIG. 19 is a graph illustrating meridional comatic aberration observed in the fourth embodiment of the infrared lens according to the first aspect of the present invention;

FIG. 20 is a graph illustrating sagittal comatic aberration observed in the fourth embodiment of the infrared lens according to the first aspect of the present invention;

FIG. 21 is a sectional view of optics of a fifth embodiment of an infrared lens in accordance with a first aspect of the present invention;

FIG. 22 is a graph illustrating spherical aberration observed in the fifth embodiment of the infrared lens according to the first aspect of the present invention;

FIG. 23 is a graph illustrating astigmatism observed in the fifth embodiment of the infrared lens according to the first aspect of the present invention;

FIG. 24 is a graph illustrating meridional comatic aberration observed in the fifth embodiment of the infrared lens according to the first aspect of the present invention;

FIG. 25 is a graph illustrating sagittal comatic aberration observed in the fifth embodiment of the infrared lens according to the first aspect of the present invention;

FIG. 26 is a sectional view of optics of a first embodiment of an infrared lens in accordance with a second aspect of the present invention;

FIG. 27 is a graph illustrating spherical aberration observed in the first embodiment of the infrared lens according to the second aspect of the present invention;

FIG. 28 is a graph illustrating astigmatism observed in the first embodiment of the infrared lens according to the second aspect of the present invention;

FIG. 29 is a graph illustrating distortion aberration observed in the first embodiment of the infrared lens according to the second aspect of the present invention;

FIG. 30 is a graph illustrating meridional comatic aberration observed in the first embodiment of the infrared lens according to the second aspect of the present invention;

FIG. 31 is a graph illustrating sagittal comatic aberration observed in the first embodiment of the infrared lens according to the second aspect of the present invention;

FIG. 32 is a sectional view of optics of a second embodiment of an infrared lens in accordance with a second aspect of the present invention;

FIG. 33 is a graph illustrating spherical aberration observed in the second embodiment of the infrared lens according to the second aspect of the present invention;

FIG. 34 is a graph illustrating astigmatism observed in the second embodiment of the infrared lens according to the second aspect of the present invention;

FIG. 35 is a graph illustrating distortion aberration observed in the second embodiment of the infrared lens according to the second aspect of the present invention;

FIG. 36 is a graph illustrating meridional comatic aberration observed in the second embodiment of the infrared lens according to the second aspect of the present invention;

FIG. 37 is a graph illustrating sagittal comatic aberration observed in the second embodiment of the infrared lens according to the second aspect of the present invention;

FIG. 38 is a sectional view of optics of a first embodiment of an infrared lens in accordance with a third aspect of the present invention;

FIG. 39 is a graph illustrating spherical aberration observed in the first embodiment of the infrared lens according to the third aspect of the present invention;

FIG. 40 is a graph illustrating astigmatism observed in the first embodiment of the infrared lens according to the third aspect of the present invention;

FIG. 41 is a graph illustrating distortion aberration observed in the first embodiment of the infrared lens according to the third aspect of the present invention;

FIG. 42 is a graph illustrating meridional comatic aberration observed in the first embodiment of the infrared lens according to the third aspect of the present invention;

FIG. 43 is a graph illustrating sagittal comatic aberration observed in the first embodiment of the infrared lens according to the third aspect of the present invention;

FIG. 44 is a sectional view of optics of a second embodiment of an infrared lens in accordance with a third aspect of the present invention;

FIG. 45 is a graph illustrating spherical aberration observed in the second embodiment of the infrared lens according to the third aspect of the present invention;

FIG. 46 is a graph illustrating astigmatism observed in the second embodiment of the infrared lens according to the third aspect of the present invention;

FIG. 47 is a graph illustrating distortion aberration observed in the second embodiment of the infrared lens according to the third aspect of the present invention;

FIG. 48 is a graph illustrating meridional comatic aberration observed in the second embodiment of the infrared lens according to the third aspect of the present invention; and

FIG. 49 is a graph illustrating sagittal comatic aberration observed in the second embodiment of the infrared lens according to the third aspect of the present invention.

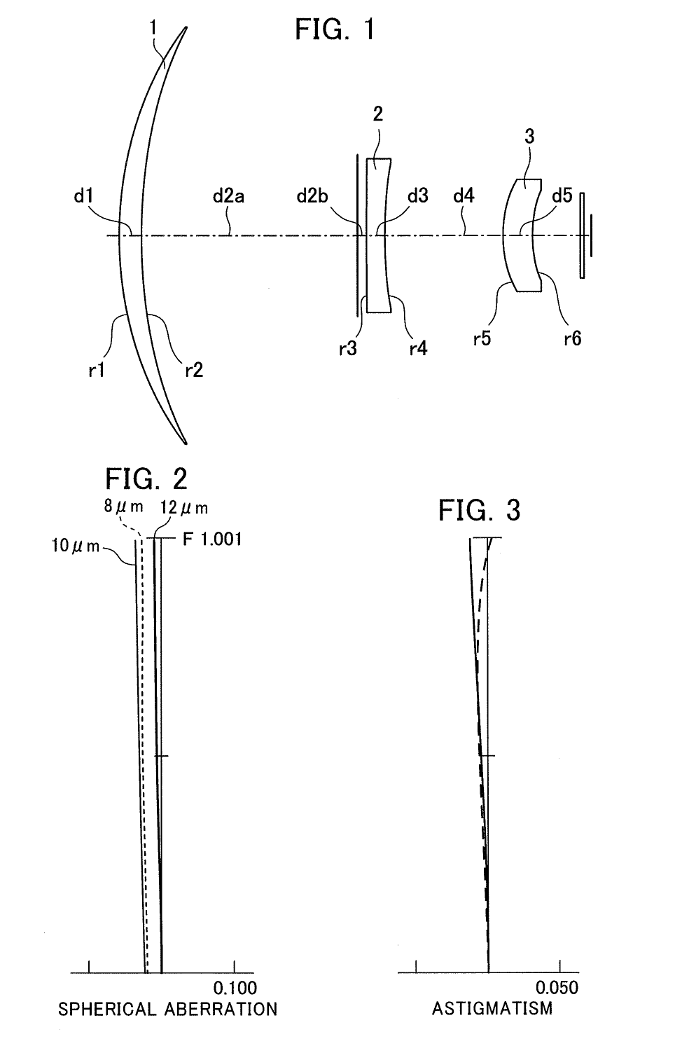

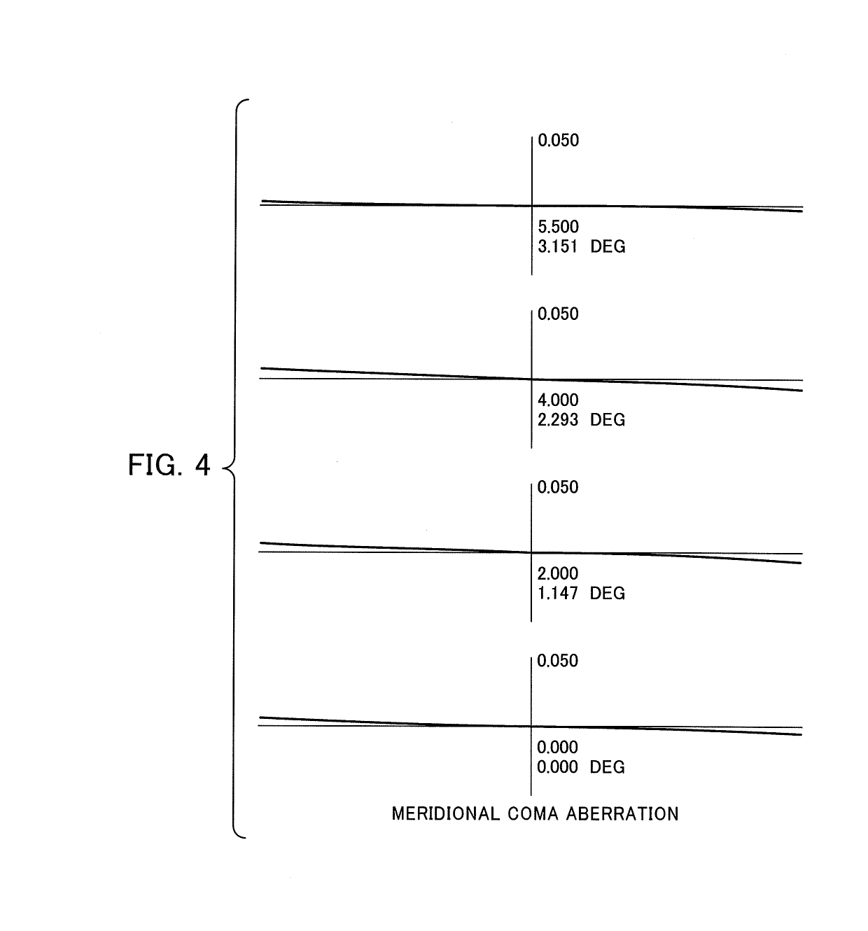

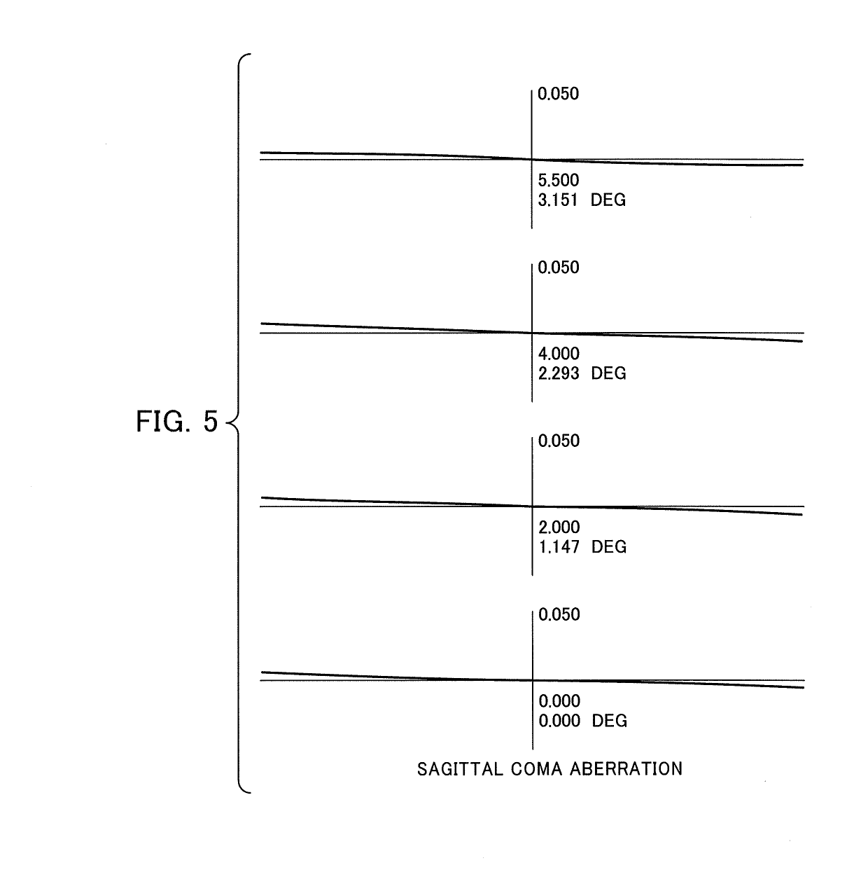

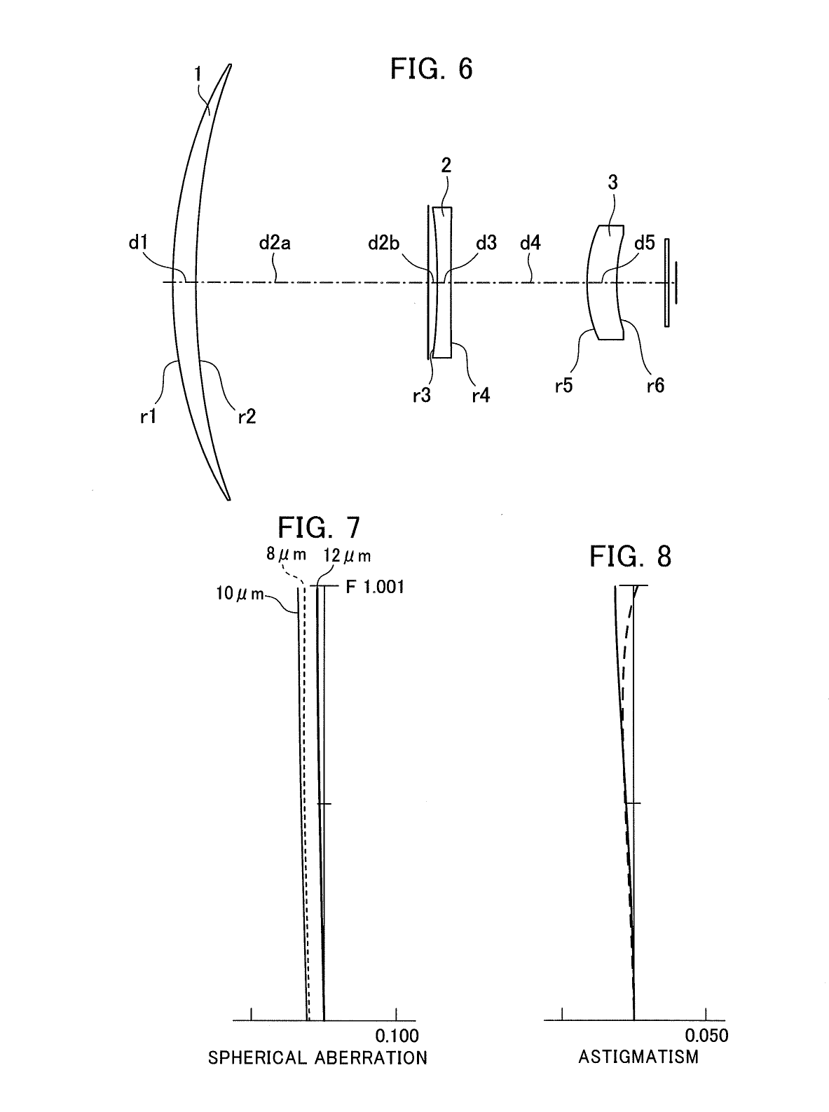

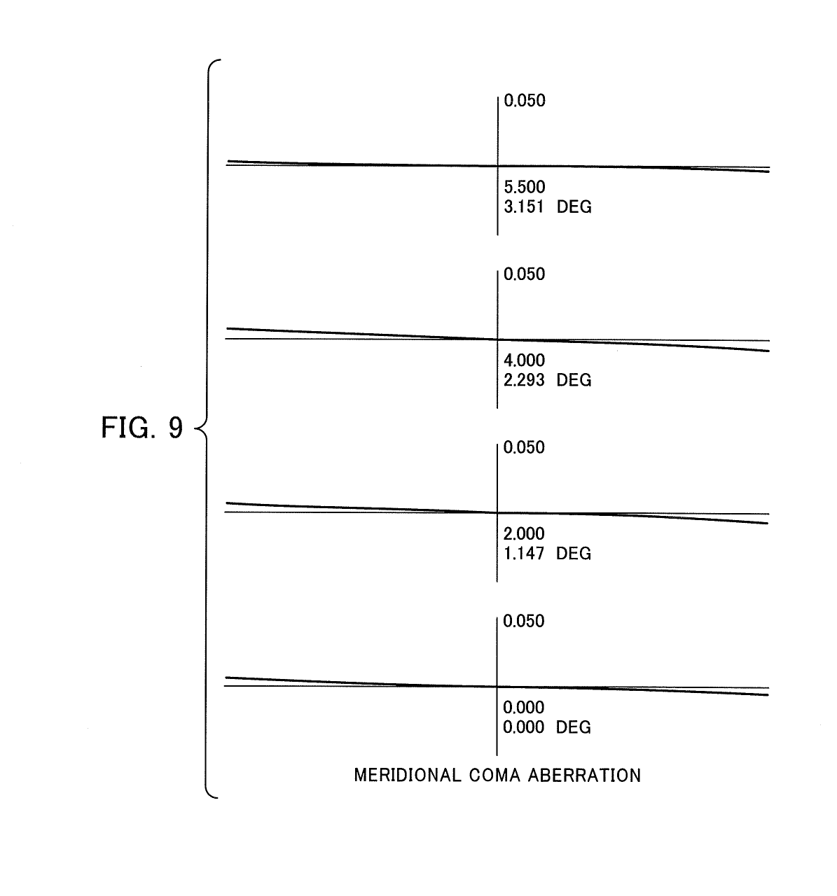

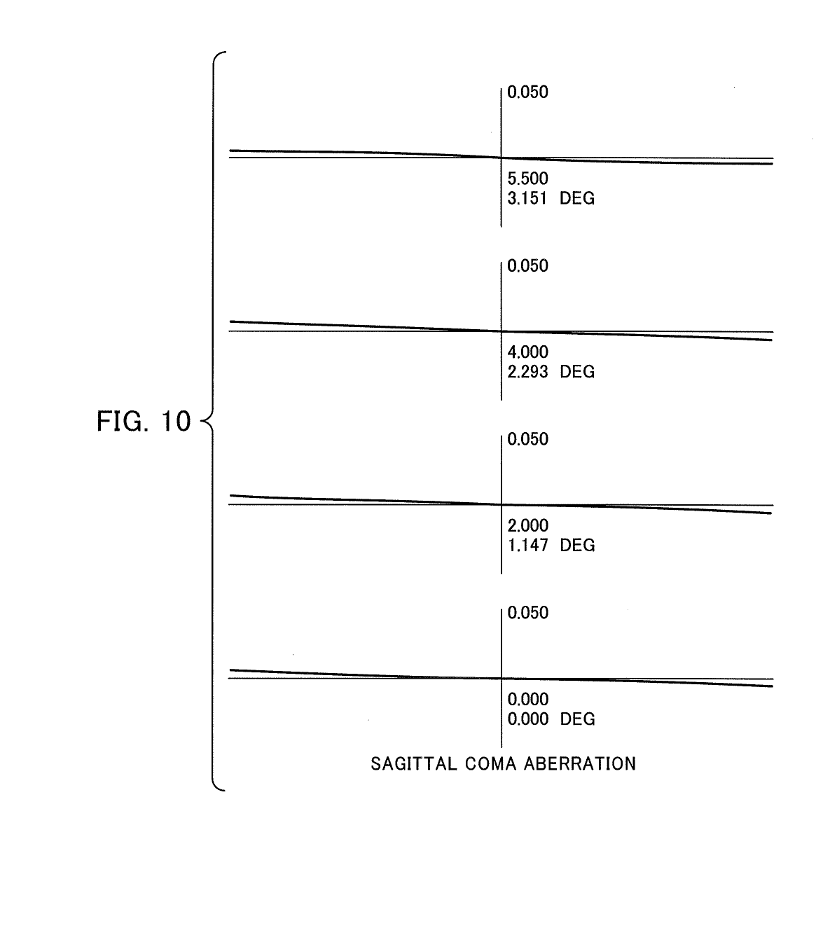

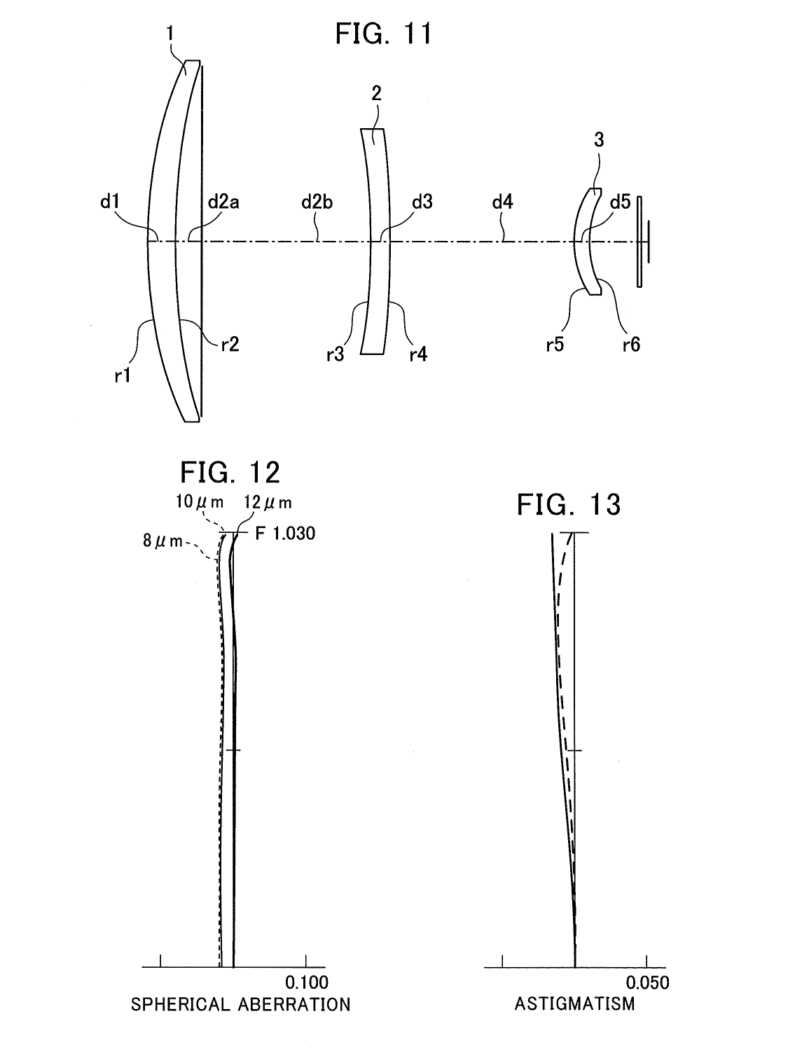

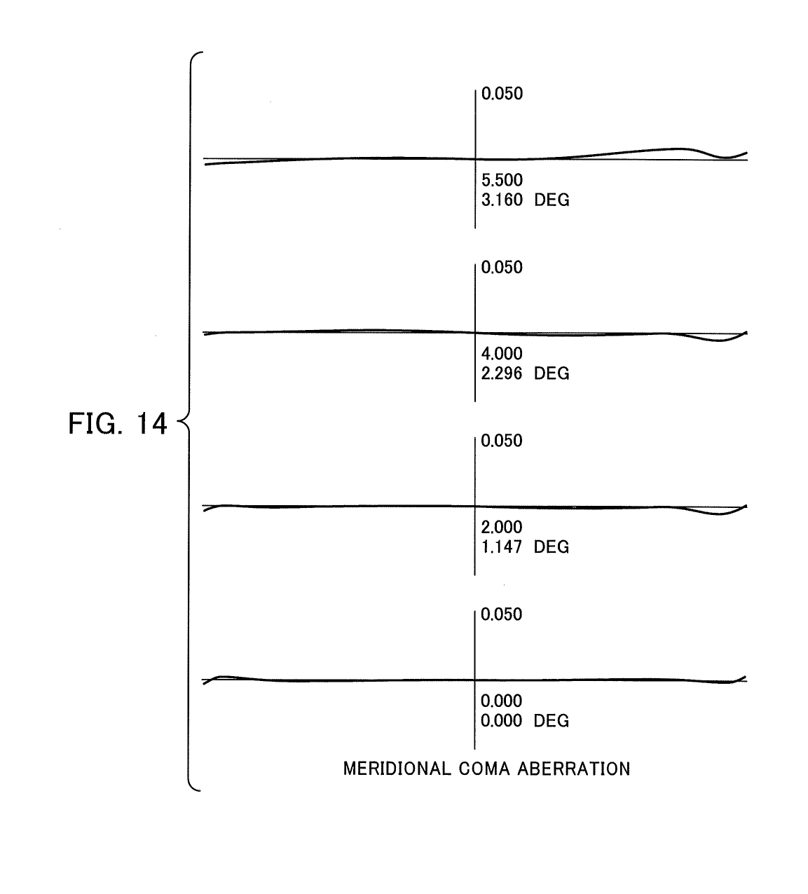

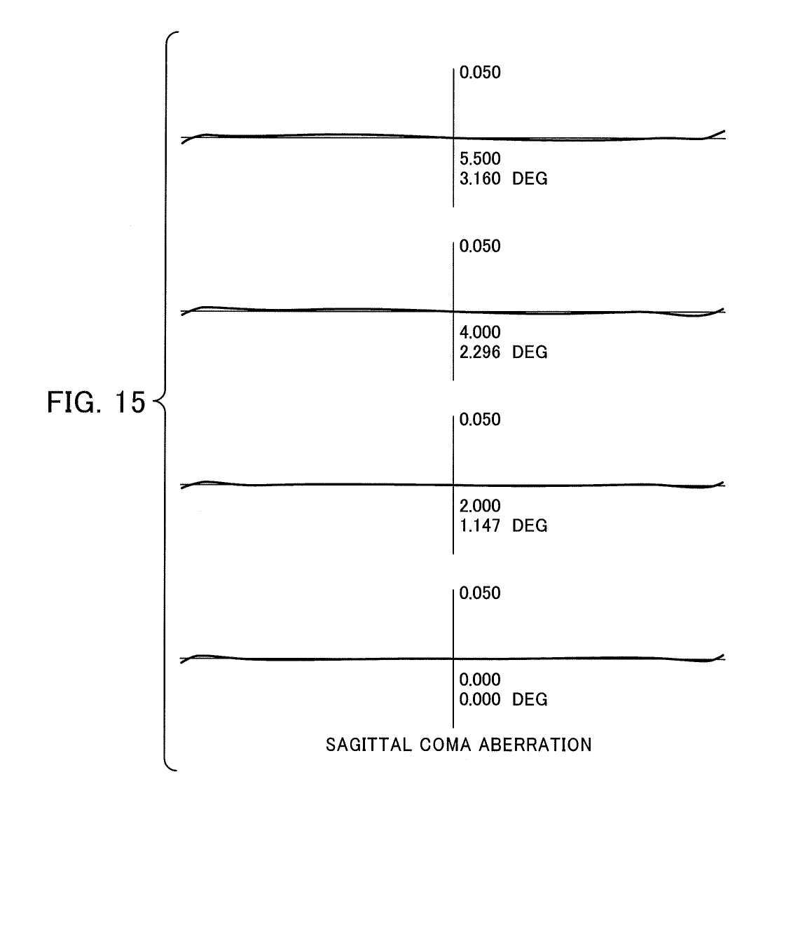

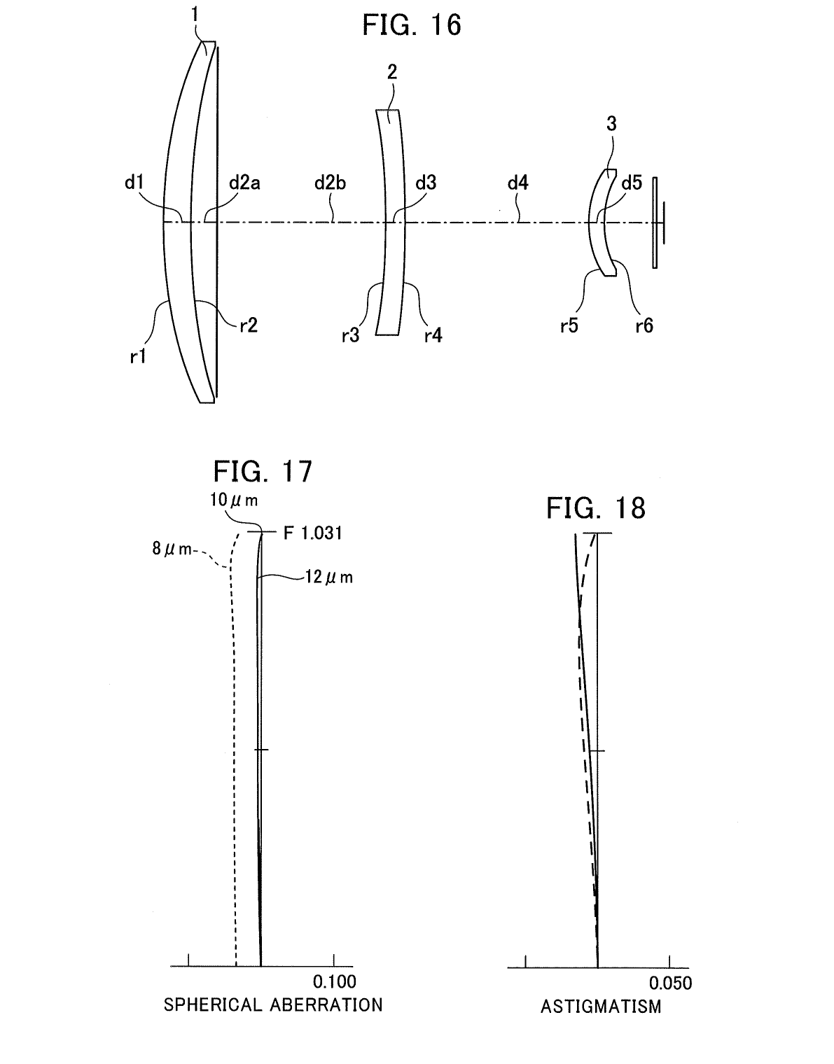

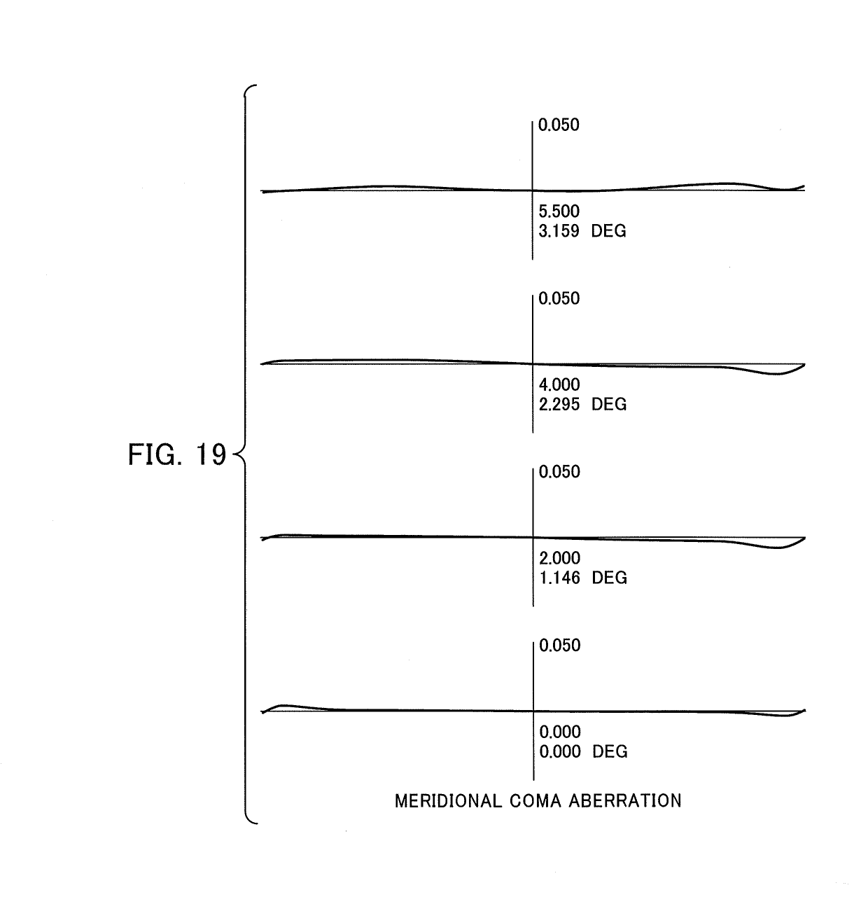

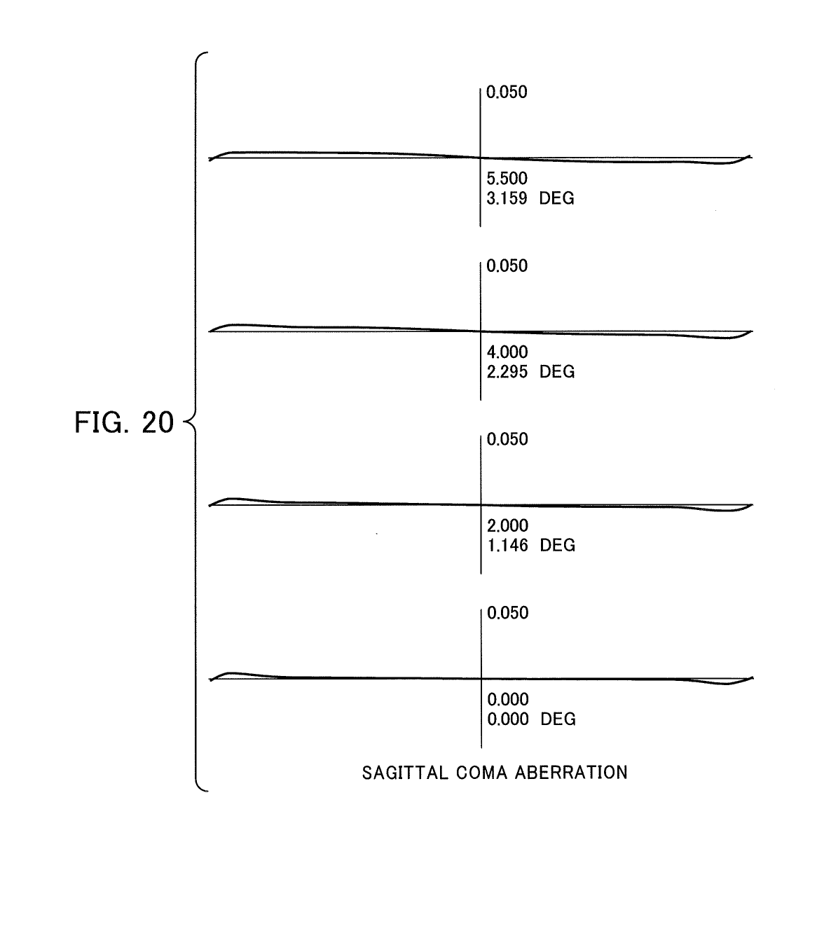

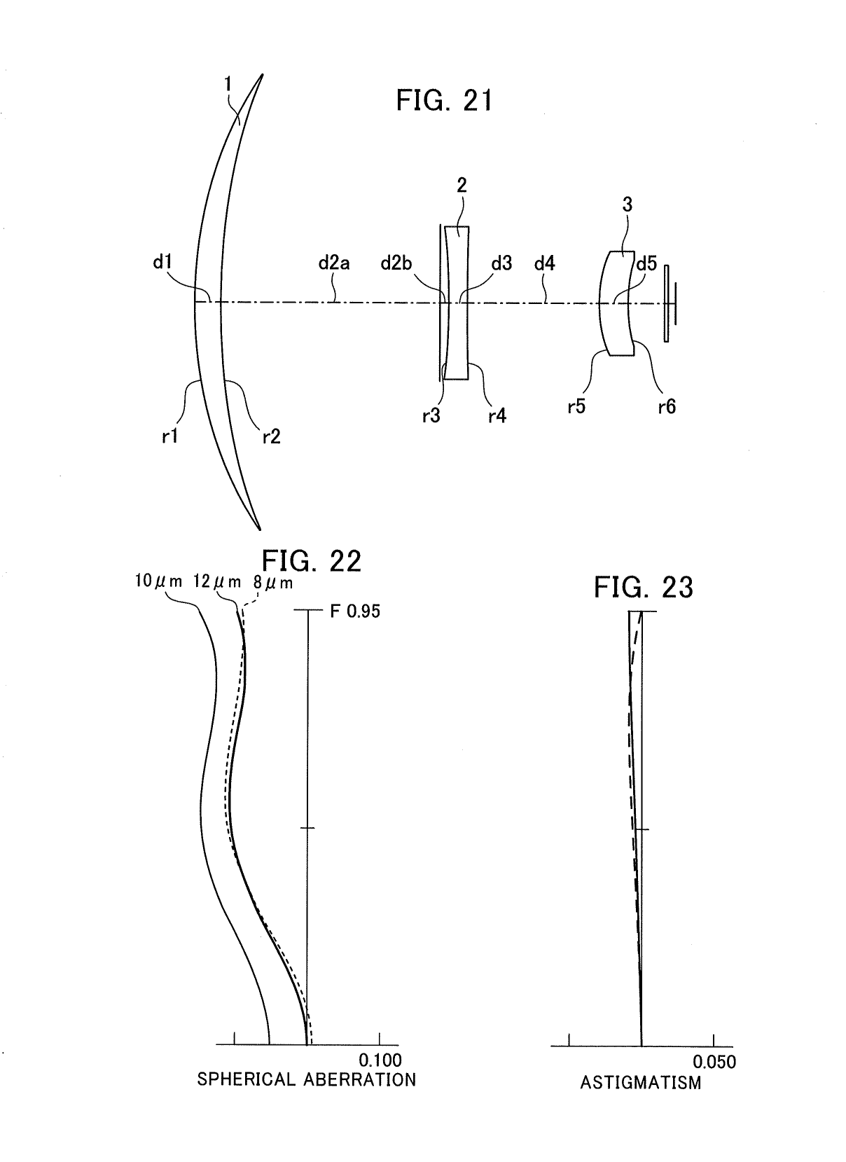

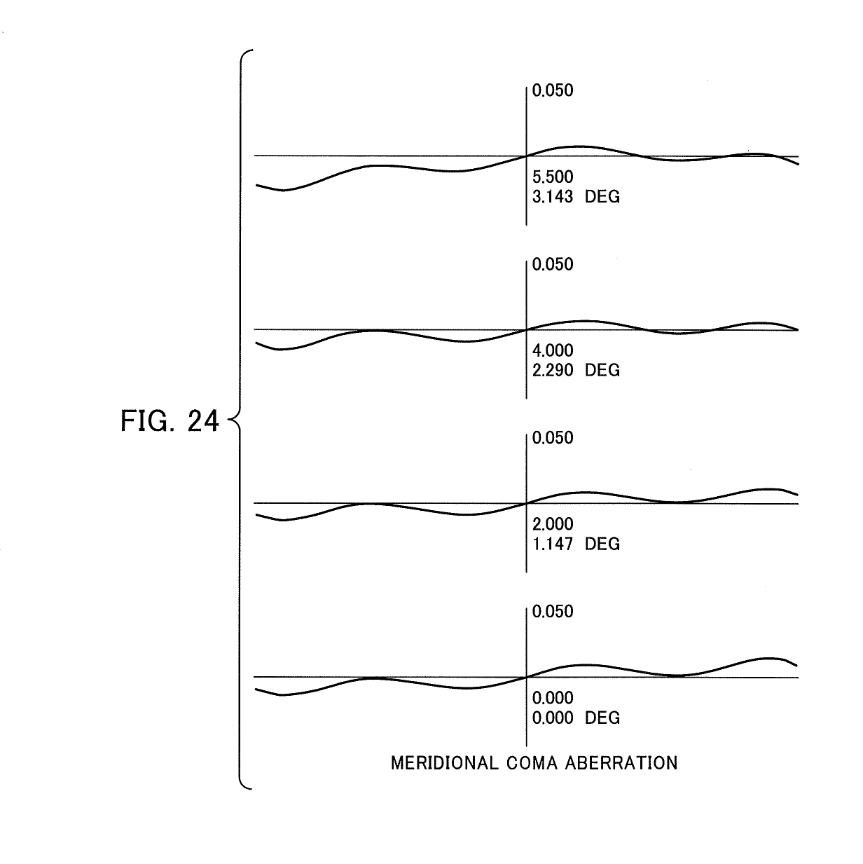

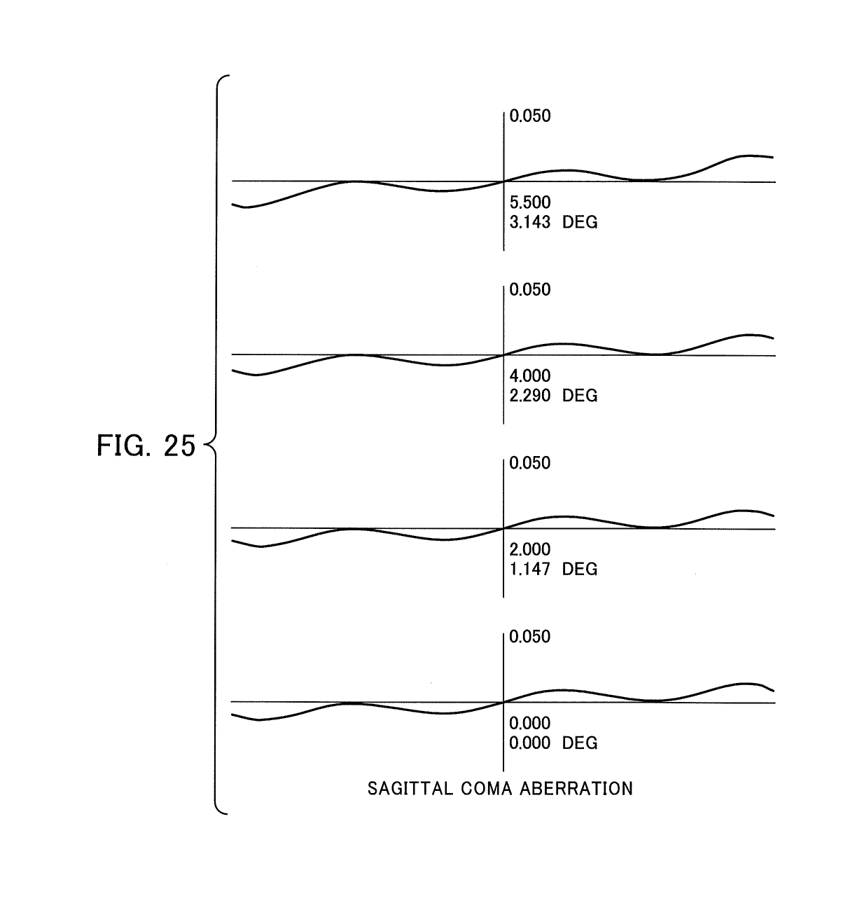

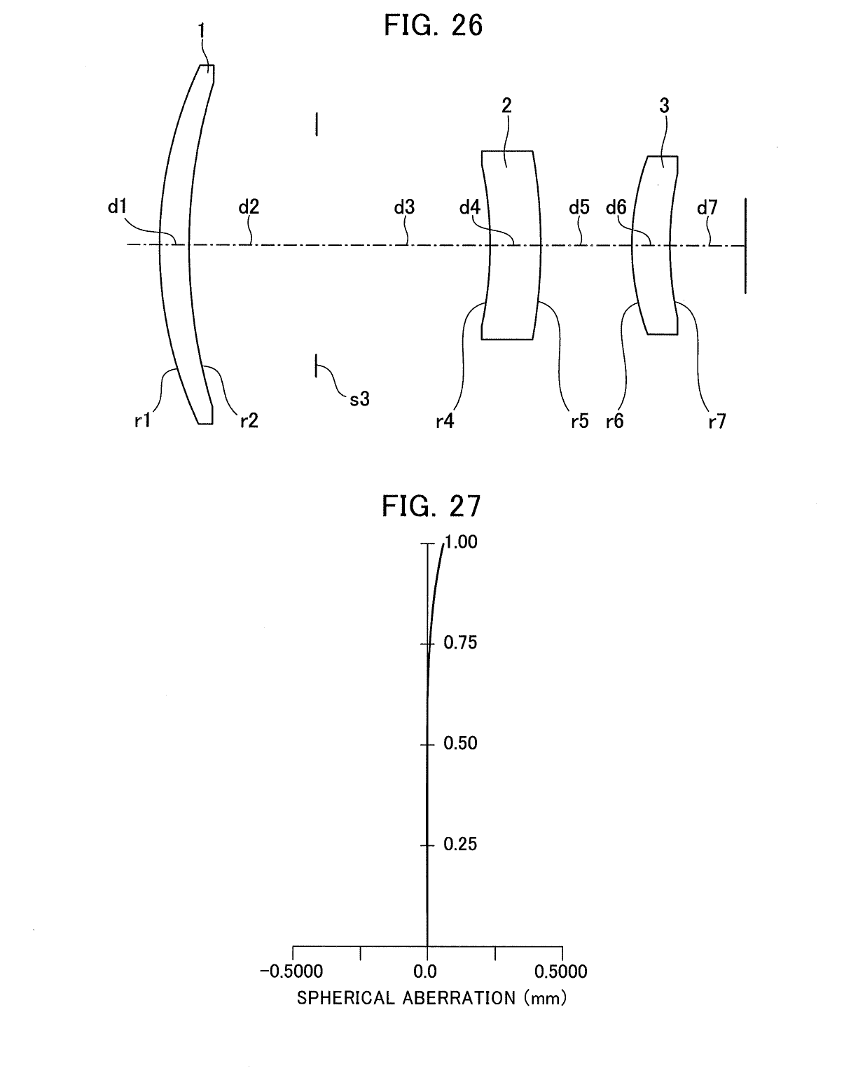

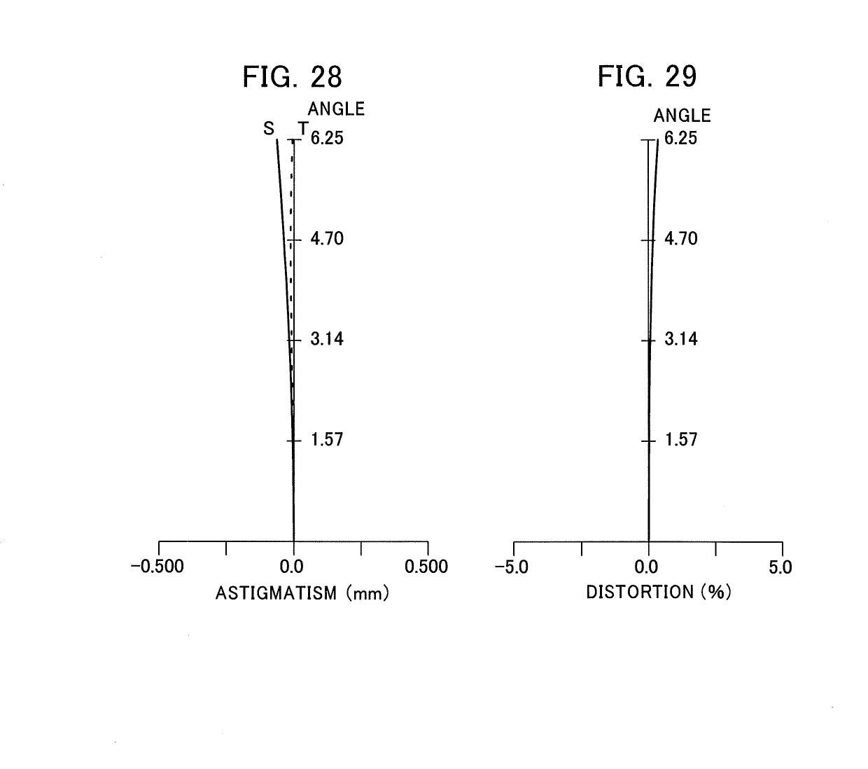

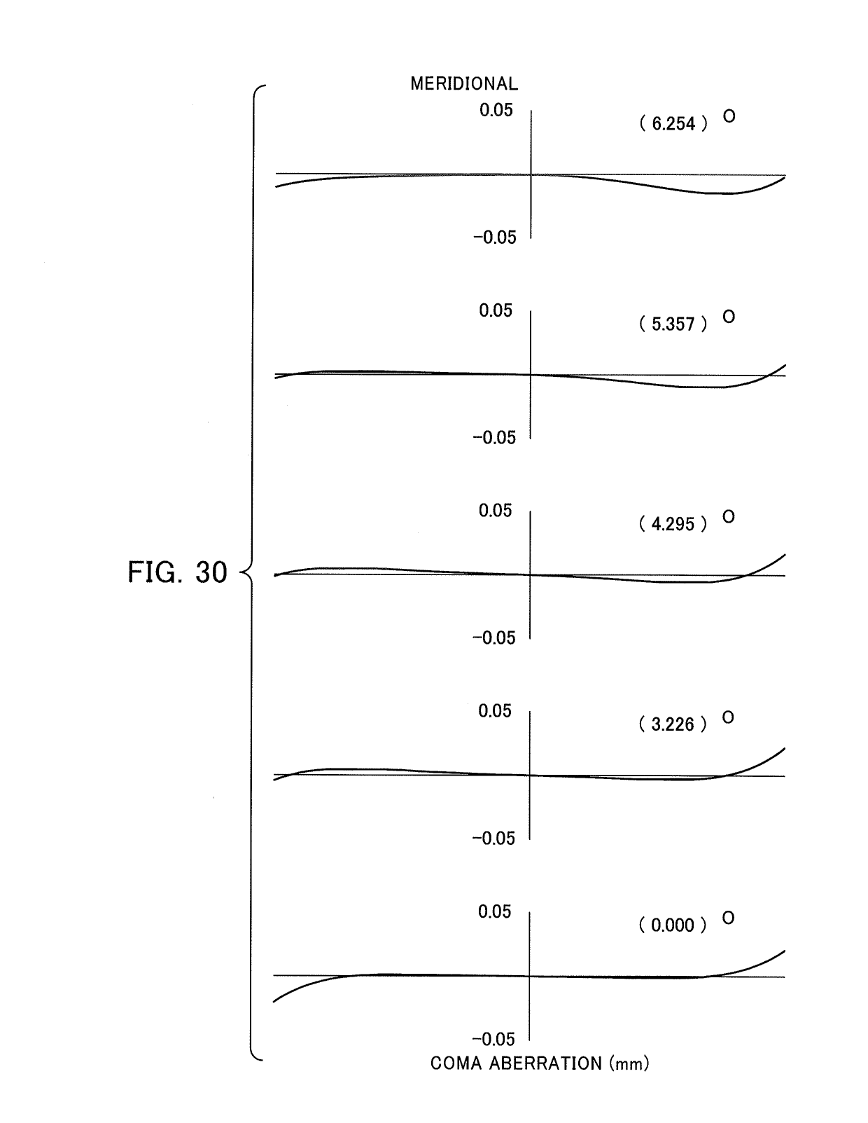

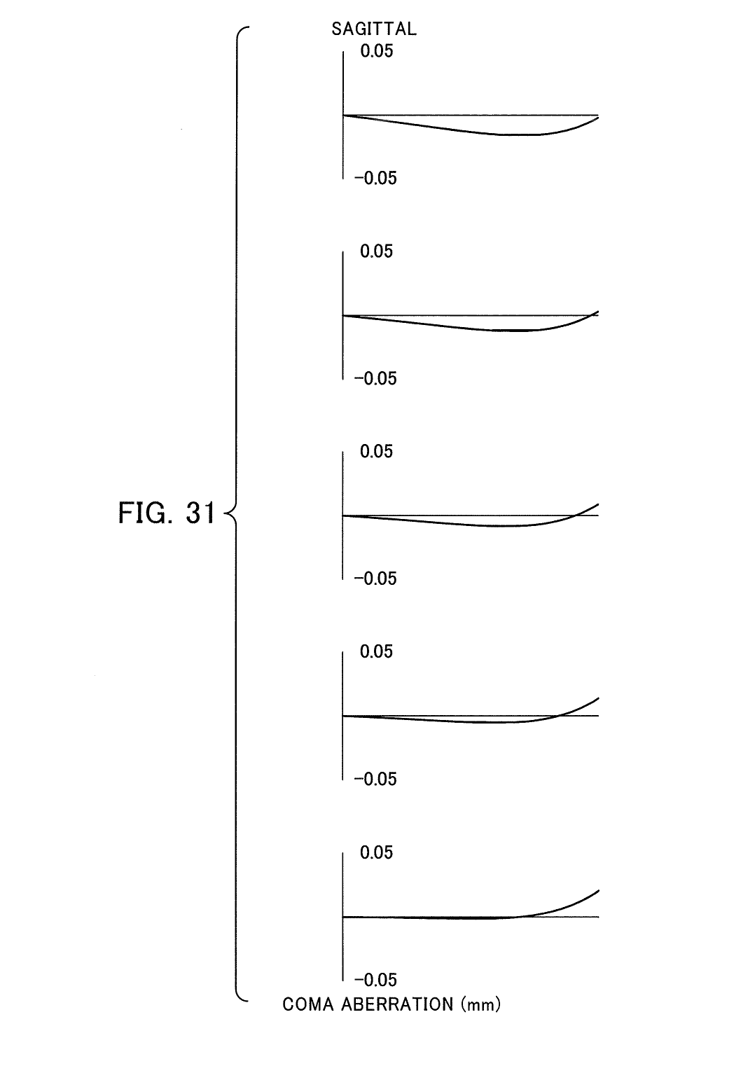

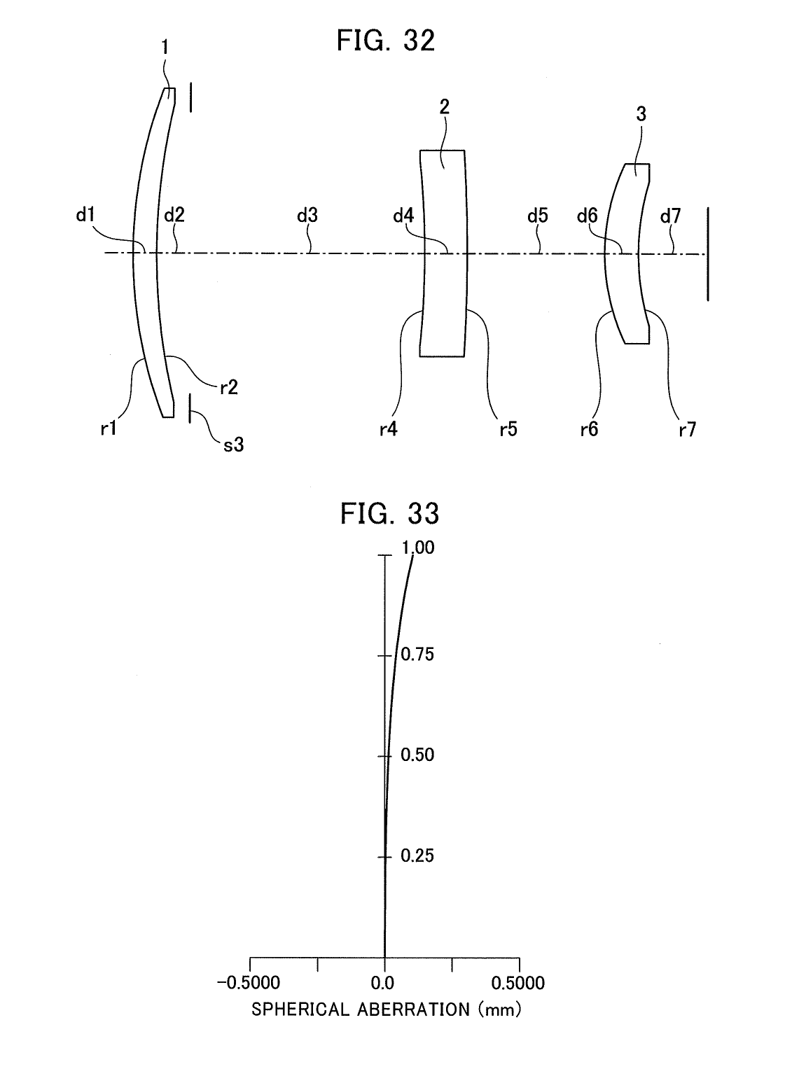

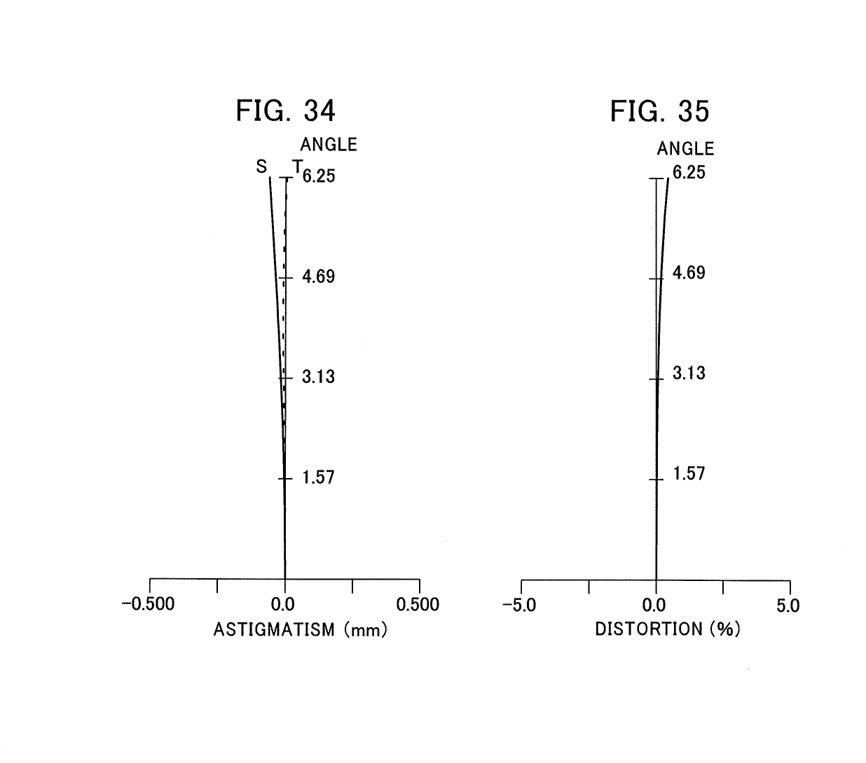

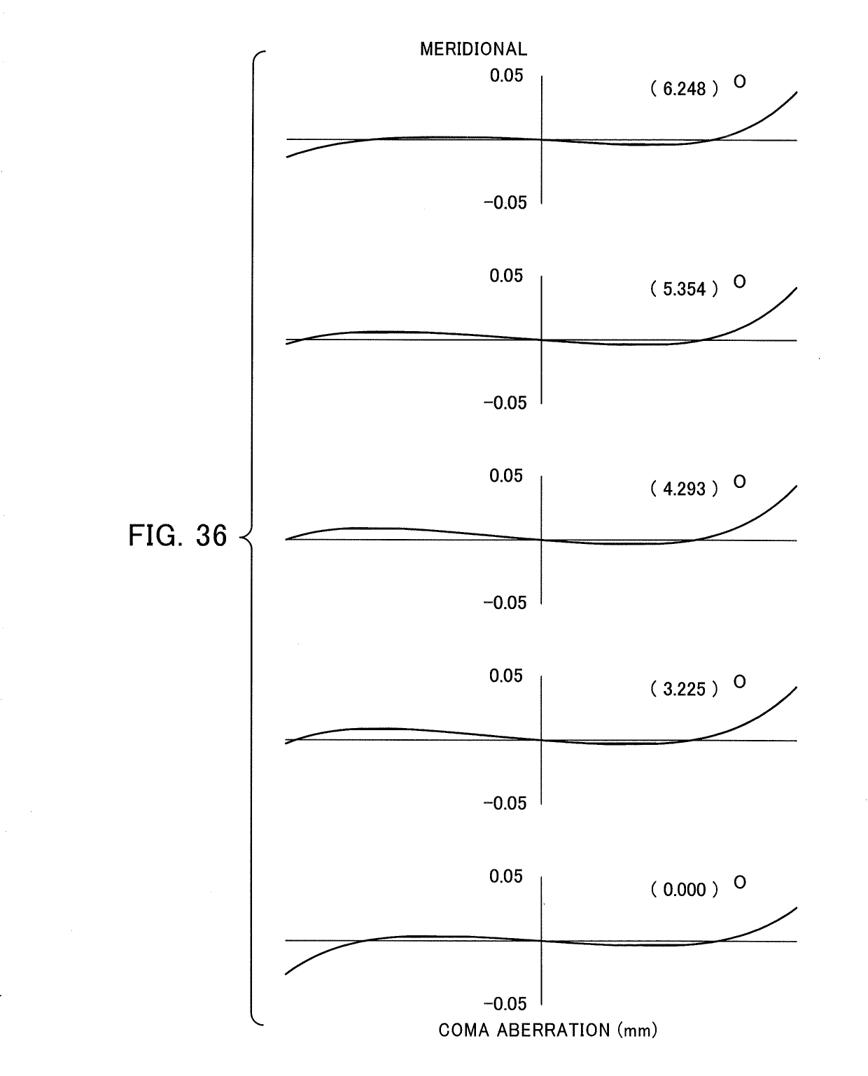

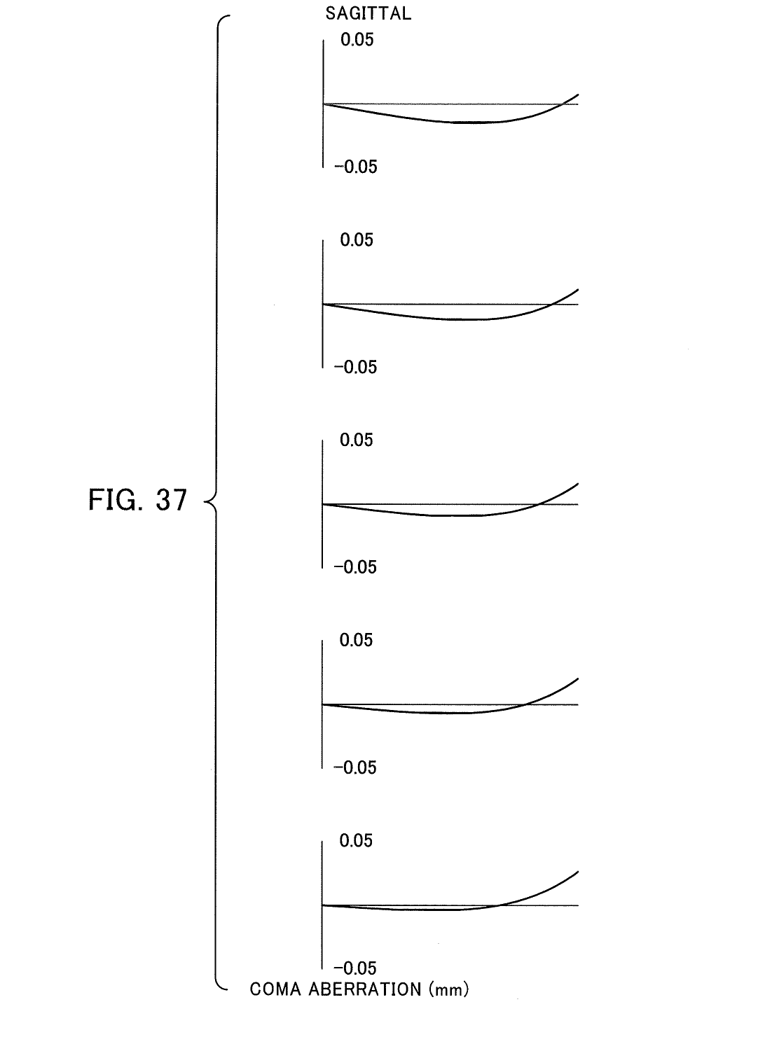

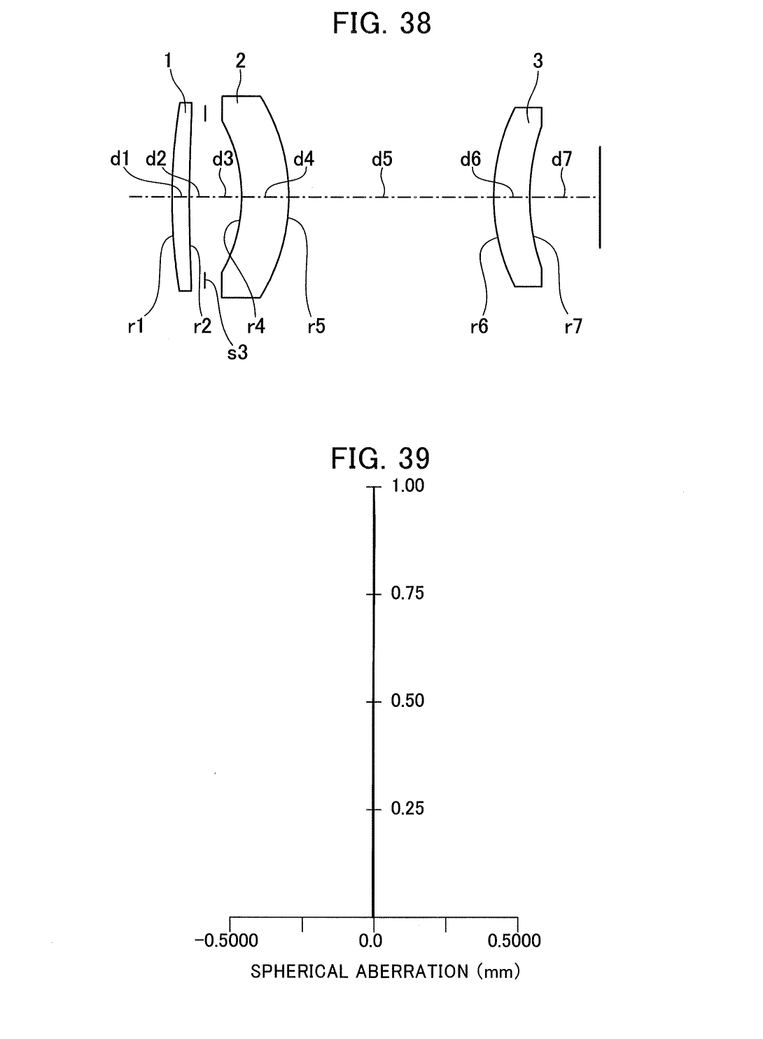

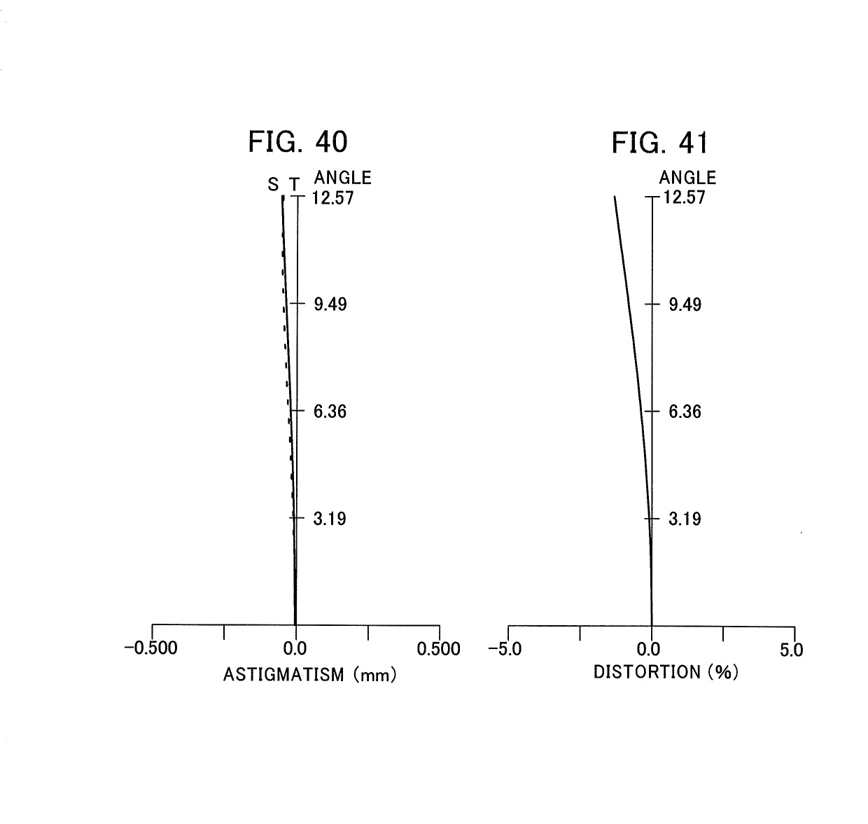

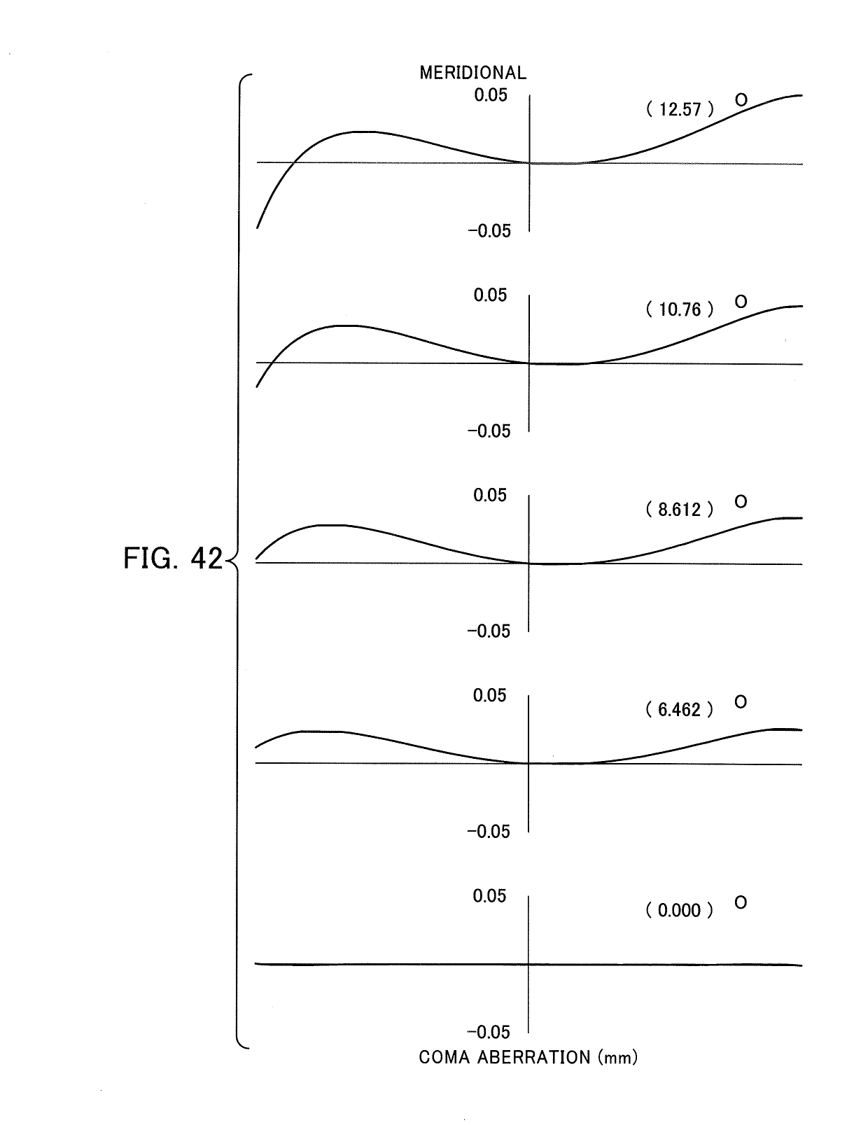

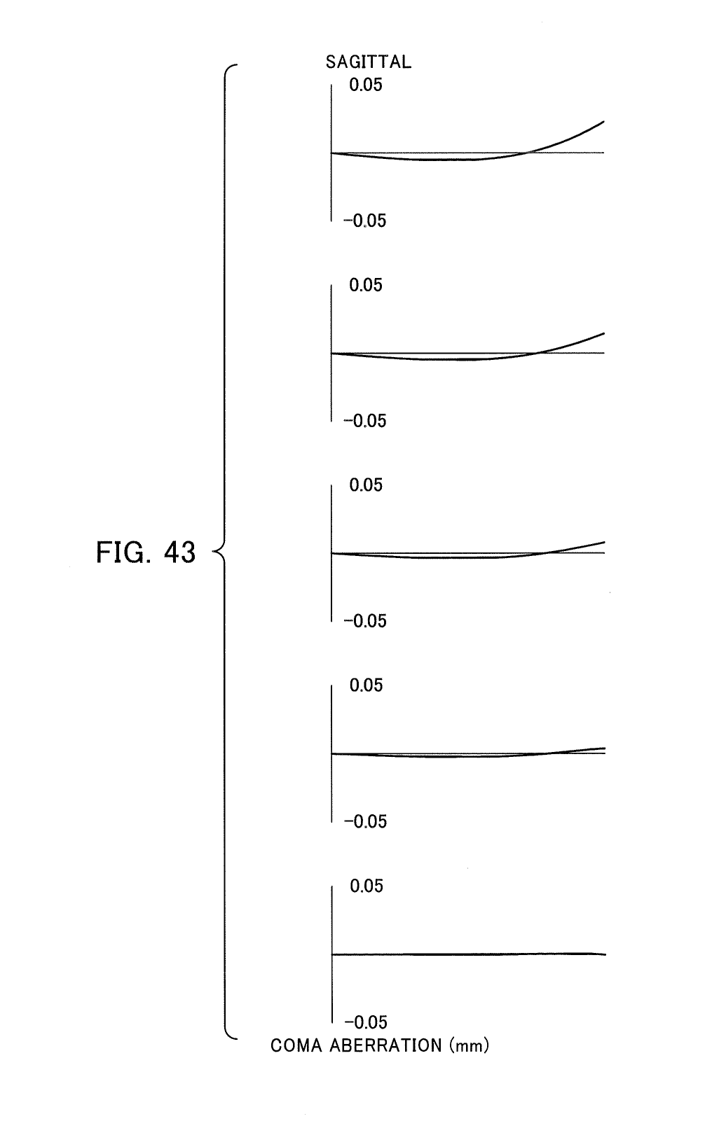

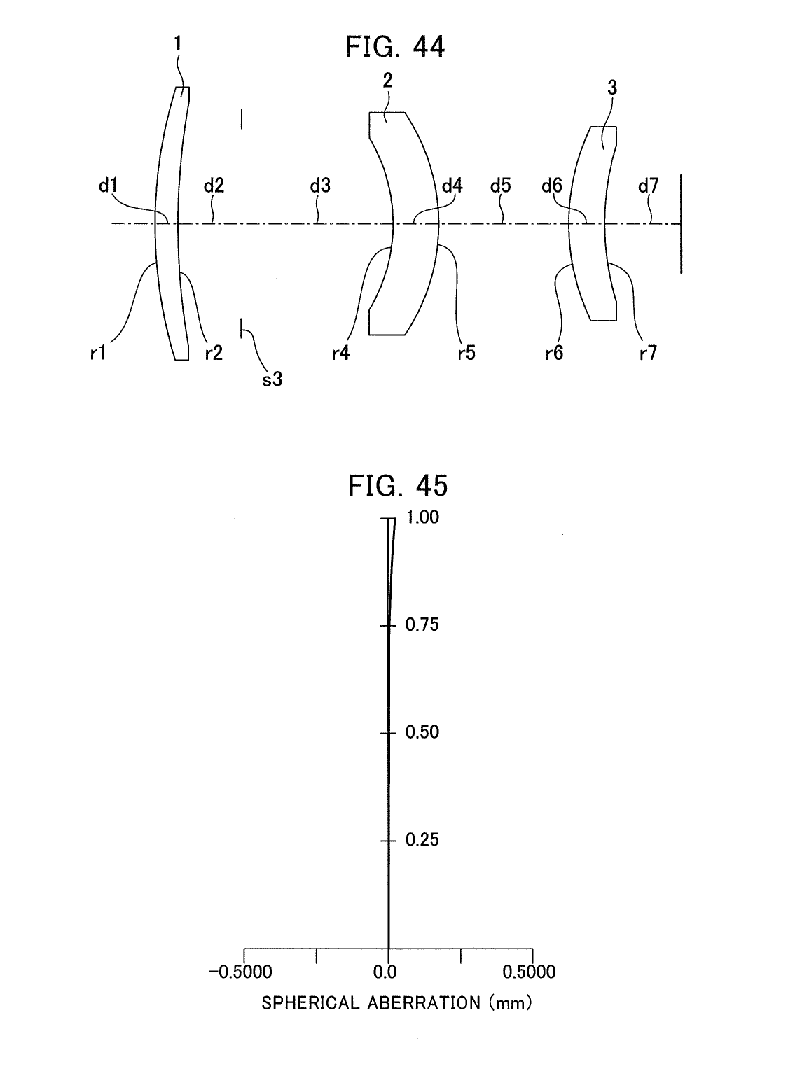

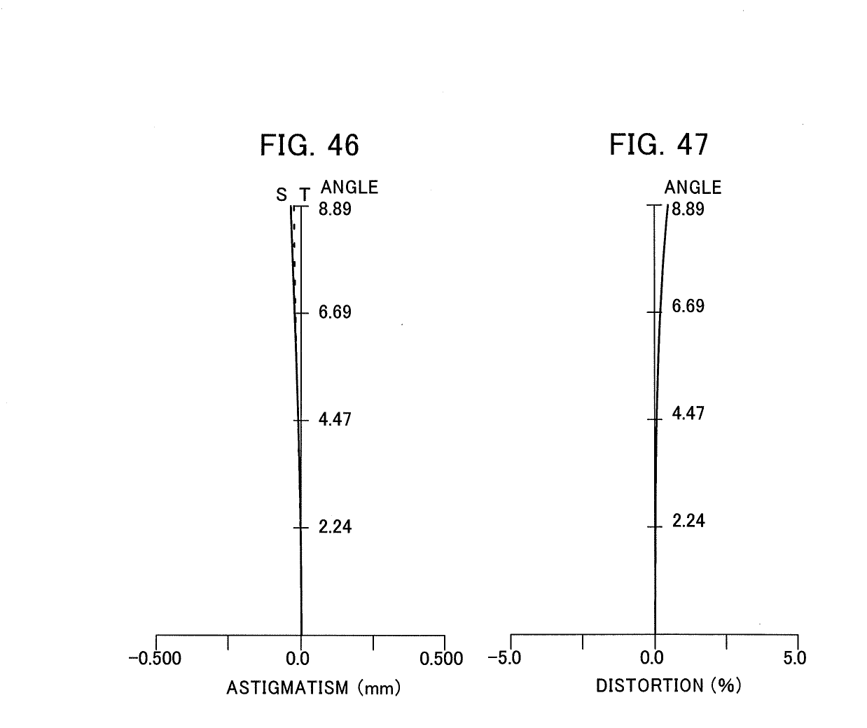

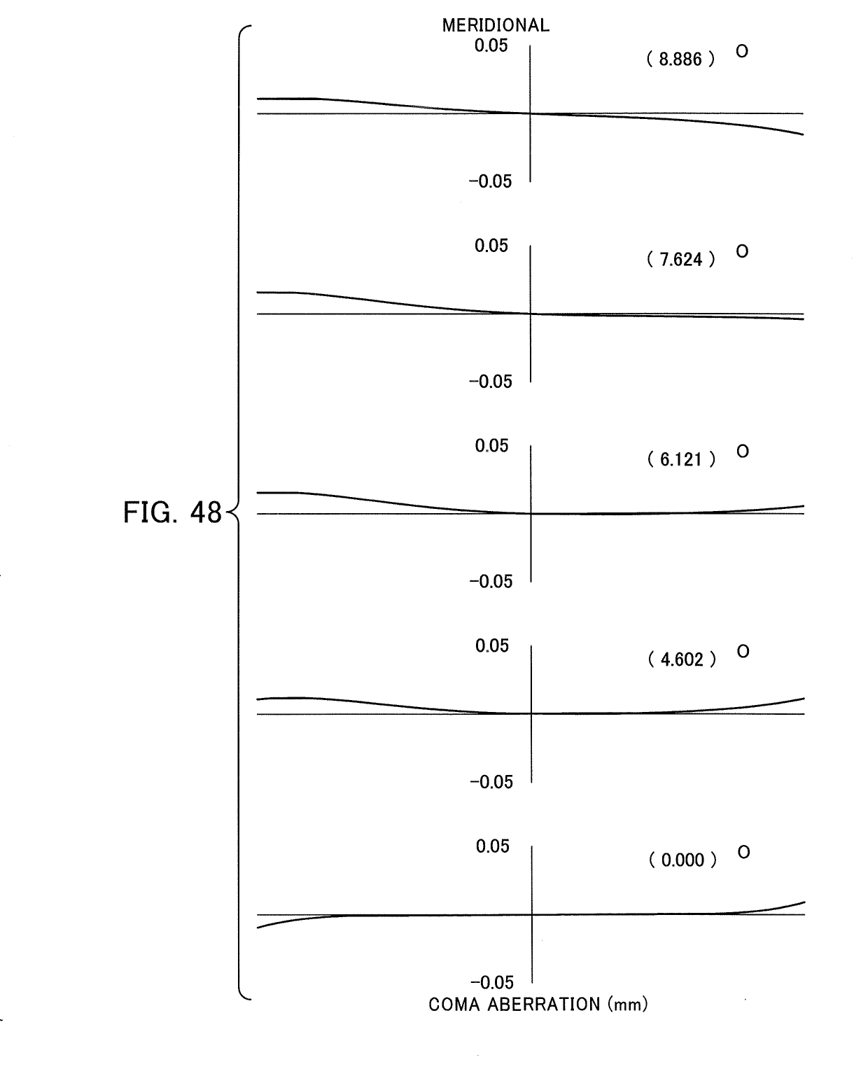

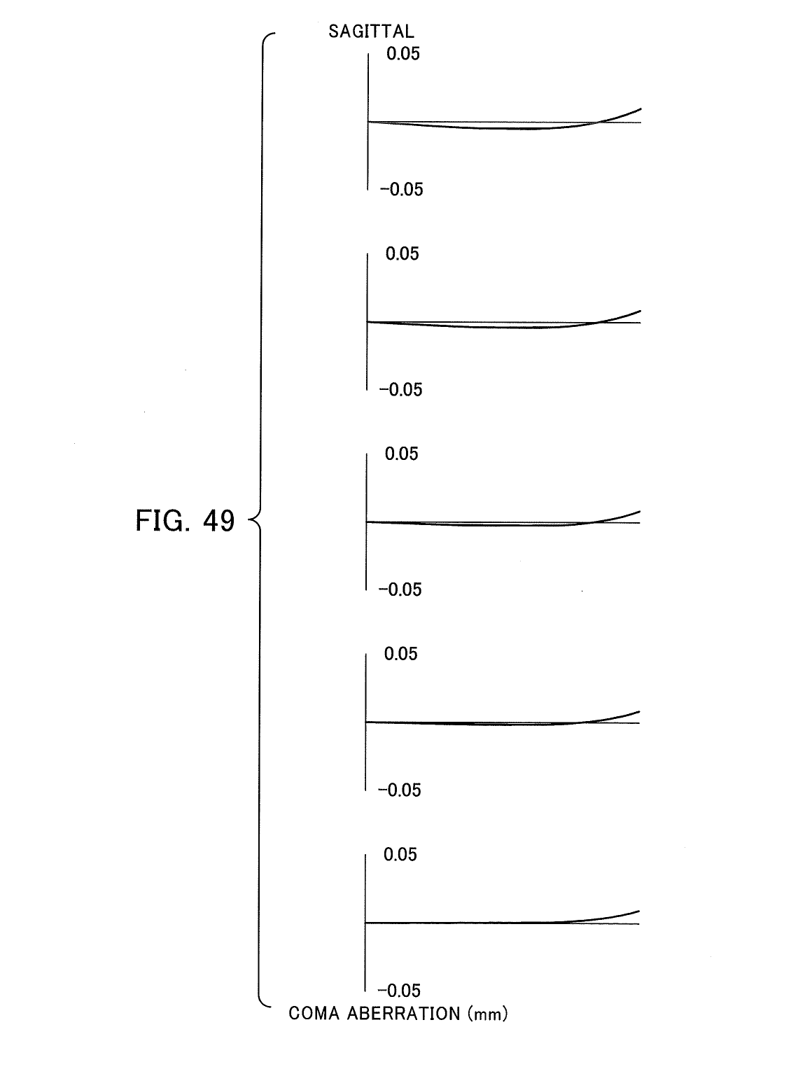

### DESCRIPTION OF THE INVENTION

### Best Mode of the Invention in the First Aspect

The invention in the first aspect will now be detailed in conjunction with various embodiments of the infrared lens as summarized in the above.

In the infrared lens, the second group of lens pieces are made of chalcogenide.

Configured in this manner, the infrared lens, which is of a substance stable in optical properties and commercial supply, can fully correct chromatic aberration for transmitted beams of light of wavelength of 10 μm and around.

Alternatively, the second group of lens pieces may be made of zinc selenide.

Configured in this manner, the infrared lens, which is of such an alternative substance stable in optical properties and commercial supply, can fully correct chromatic aberration for transmitted beams of light of wavelength of 10 μm and around.

Further alternatively, the first and second groups of lens pieces may be made of germanium.

Configured in this manner, the infrared lens, which has its optics reduced in light absorption and given greater refractive power, can create images with adverse effects of chromatic aberration fully corrected, and production of the infrared lens can benefit from stable supply of such a lens material.

The infrared lens in the first aspect meets requirements as defined in the following formula:

0.8≦f/f1≦1.1 (10)

where f is a focal length of the infrared lens, and f1 is the focal length of the first group of lens pieces.

Configured in this manner, the IR lens is capable of reducing spherical aberration to an acceptable level, and especially of enhancing axial resolution.

The infrared lens in the first aspect of the invention has one of the opposite surfaces of at least one of lens pieces made aspherical in shape.

Configured in this manner, the IR lens is capable of reducing spherical aberration to an acceptable level.

Alternatively, the infrared lens in the first aspect of the invention has one of the opposite surfaces of at least one of lens pieces micro-machined to serve as an aspherical diffraction grating.

Configured in this manner, the IR lens is capable of reducing chromatic aberration to an acceptable level.

A yet further alternative infrared lens in the first aspect of the invention has its third group of lens pieces displaced in directions orthogonal to the optical axis so as to compensate for image sway.

The third lens group is smaller in diameter and lighter than the first lens group, and is more suitably displaced in the directions orthogonal to the optical axis. A driving mechanism for forcedly displacing the third lens group in the directions orthogonal to the optical axis is placed in the middle or hind area of the lens optics, and hence, the IR lens, as a whole, can be advantageously downsized.

### Best Mode of the Invention in the Second Aspect

The invention in the second aspect will now be detailed in conjunction with various embodiments of the infrared lens as summarized in the above.

In the infrared lens, the first to third groups of lens pieces are made of germanium.

Configured in this manner, the infrared lens, which has its optics reduced in light absorption and given greater refractive power, can create images with adverse effects of chromatic aberration fully corrected, and production of the infrared lens can benefit from stable supply of such a lens material.

Alternatively, the infrared lens may have the first to third lens groups each of which consists of a single lens piece.

By virtue of such a single-lens design where the component lens pieces are reduced in number in all the lens groups, a manufacturing cost can be reduced. This single-lens design is also useful to minimize the number of air contact surfaces of the lens pieces, so that light loss due to reflection from the surfaces of the lens pieces is decreased and that stray light due to the reflection from the surfaces of the lens pieces is prevented from causing a reduction in image contrast.

An alternative infrared lens in the second aspect of the invention meets a requirement as defined in the following formula:

0.9<|r4|/f (11)

where f is a focal length of the IR lens, and r4 is a curvature of a front surface of the lens piece closest to an object in the second lens group.

The requirement in the formula (11) gives a limit within which the IR lens compensates for spherical aberration to an acceptable level. When the IR lens does not meet the requirement in the formula, adverse effects of the spherical aberration are more conspicuous.

Alternatively, the infrared lens in the second aspect of the invention may meet requirements as defined in the following formulae:

0.5<(|r4|+d4)/|r5|<0.86 (12)

where r4 is a curvature of a front surface of the lens piece closest to an object in the second lens group, r5 is a rear surface of the lens piece closest to an imaging plane in the second lens group, and d4 is a thickness of the second lens group.

The formulae (12) provide limits within which the IR lens compensates for spherical aberration to an acceptable level. When the IR lens does not meet the requirements in the formulae, adverse effects of the spherical aberration are more conspicuous.

The infrared lens in the second aspect of the invention may alternatively meet requirements as defined in the following formulae:

1.0<f1/f<1.5 (13)

where f is a focal length of the IR lens, and f1 is the focal length of the first group of lens pieces.

The formulae (13) provides limits within which the IR lens compensates for comatic aberration to an acceptable level. When the IR lens fails to meet the requirements, adverse effects of the comatic aberration are more conspicuous.

Further alternatively, the infrared lens in the second aspect of the invention may meet requirements as defined in the following formulae:

0.2<bf/f3<0.4 (14)

where bf is a back focus of the IR lens, and f3 is a focal length of the third lens group.

The formulae (14) provide limits within which the IR lens compensates for comatic aberration to an acceptable level. When the IR lens fails to meet the requirements, adverse effects of the comatic aberration are more conspicuous.

A yet further alternative infrared lens in the second aspect of the invention has its third group of lens pieces displaced in directions orthogonal to the optical axis so as to compensate for image sway.

The third lens group is smaller in diameter and lighter than the first lens group, and is more suitably displaced in the directions orthogonal to the optical axis. A driving mechanism for forcedly displacing the third lens group in the directions orthogonal to the optical axis is placed in the middle or hind area of the lens optics, and hence, the IR lens, as a whole, can be advantageously downsized.

### Best Mode of the Invention in the Third Aspect

The invention in the third aspect will now be detailed in conjunction with various embodiments of the infrared lens as summarized in the above.

In the infrared lens, the first to third groups of lens pieces are made of germanium.

Configured in this manner, the infrared lens, which has its optics reduced in light absorption and given greater refractive power, can create images with adverse effects of chromatic aberration fully corrected, and production of the infrared lens can benefit from stable supply of such a lens material.

Alternatively, the infrared lens may have the first to third lens groups each of which consists of a single lens piece.

By virtue of such a single-lens design where the component lens pieces are reduced in number in all the lens groups, a manufacturing cost can be reduced. This single-lens design is also useful to minimize the number of air contact surfaces of the lens pieces, so that light loss due to reflection from the surfaces of the lens pieces is decreased and that stray light due to the reflection from the surfaces of the lens pieces is prevented from causing a reduction in image contrast.

The infrared lens may meet requirements as defined in the following formulae:

0.4<d5/f3<0.75 (15)

where d5 is a focal length of the second lens group, and f3 is the focal length of the third lens group.

The formulae (15) provides limits within which the IR lens compensates for astigmatism to an acceptable level. When the IR lens fails to meet the requirements in the formulae (15), adverse effects of the astigmatism are more conspicuous.

Another alternative of the infrared lens in the third aspect of the invention may meet requirements as defined in the following formulae:

0.6<f3/f<1.3 (16)

where f3 is a focal length of the third lens group, and f is the focal length of the IR lens.

The formulae (16) provide limits within which the IR lens compensates for astigmatism to an acceptable level. When the IR lens fails to meet the requirements in the formulae (16), adverse effects of the astigmatism are more conspicuous.

The infrared lens may meet requirements as defined in the following formulae:

1.0<f1/f<1.5 (17)

where f1 is a focal length of the first lens group while f is the focal length of the IR lens.

The formulae (17) provide limits within which the IR lens compensate for astigmatism to an acceptable level. When the IR lens fails to meet the requirements, adverse effects of the astigmatism are more conspicuous.

The infrared lens in the third aspect of the invention may meet requirements as defined in the following formulae:

0.2<bf/f3<0.4 (18)

where f3 is a focal length of the third lens group while bf is a back focus of the IR lens.

The formulae (18) provide limits within which the IR lens compensate for astigmatism to an acceptable level. When the IR lens fails to meet the requirements, adverse effects of the astigmatism are more conspicuous.

A yet further alternative infrared lens in the first aspect of the invention has its third group of lens pieces displaced in directions orthogonal to the optical axis so as to compensate for image sway.

The third lens group is smaller in diameter and lighter than the first lens group, and is more suitably displaced in the directions orthogonal to the optical axis. A driving mechanism for forcedly displacing the third lens group in the directions orthogonal to the optical axis is placed in the middle or hind area of the lens optics, and hence, the IR lens, as a whole, can be advantageously downsized.

### More Details of the Embodiments

Lens data on each embodiment of the infrared lens according to the present invention will be given below. Wavelength of light transmitted through the IR lens is 10 μm.

### 1. The 1st Embodiment of the IR lens in the 1st Aspect of the Invention

| | |
|---|---|
| Focal Length | 99.95 mm |
| Entire Length of the Optics | 126.86 mm |
| Back Focus | 15.95 mm |
| F-Number | 1.0 |
| Half-Angle of View | 3.17° |
| Image Height | 5.5 mm |

| # | R | d | r | n | f |
|---|---|---|---|---|---|
| 1 | 97.2692 | 6.0 | 56.1 | 4.0052 | 104.567 |
| | | | | | (Germanium) |
| 2 | 134.355 | 57.92 | 55.9 | | |
| S | | 2.4 | 21.7 | | |
| 3 | 1783.56 | 4.93 | 20.7 | 2.5861 | −77.984 |
| | | | | | (Chalcogenide) |
| 4 | 115.472 | 31.66 | 19.6 | | |
| 5 | 31.5434 | 8.0 | 15.1 | 4.0052 | 48.7808 |
| | | | | | (Germanium) |
| 6 | 32.5432 | 4.0 | 12.2 | | |

# Surface Number
R Radius of Curvature
d Lens Thickness or Distance between the Adjacent Surfaces
r Lens radius
n Refractive Index
f Focal Length
S Aperture Stop

Given below is a value of the term f/f1 in the formulae (10) for the first embodiment of the IR lens in the first aspect of the invention.

f/f1=0.95585

### 2. The 2nd Embodiment of the IR lens in the 1st Aspect of the Invention

| | |
|---|---|
| Focal Length | 99.94 mm |
| Entire Length of the Optics | 133.99 mm |
| Back Focus | 14.98 mm |
| F-Number | 1.0 |
| Half-Angle of View | 3.15° |
| Image Height | 5.5 mm |

| # | R | d | r | n | f |
|---|---|---|---|---|---|
| 1 | 122.547 | 6.2 | 58.6 | 4.0052 | 110.146 |
| | | | | | (Germanium) |
| 2 | 187.2 | 62.33 | 58.4 | | |
| S | | 2.4 | 20.6 | | |
| 3 | −164.46 | 3.54 | 20.2 | 2.5861 | −86.691 |
| | | | | | (Chalcogenide) |
| 4 | 849.936 | 36.54 | 20.0 | | |
| 5 | 38.0357 | 8.0 | 15.3 | 4.0052 | 41.7968 |
| | | | | | (Germanium) |
| 6 | 45.9462 | 4.0 | 13.0 | | |

# Surface Number
R Radius of Curvature
d Lens Thickness or Distance between the Adjacent Surfaces
r Lens radius
n Refractive Index
f Focal Length
S Aperture Stop

The surfaces #3 and #4 of the second embodiment of the IR lens in the first aspect of the invention are aspherical surfaces as expressed by the following formula:

$$X = \frac{{H}^{2} / R}{1 + \sqrt{1 - ( {kH}^{2} / R )}} + {AH}^{4} + {BH}^{6} + {CH}^{8} \qquad ( 19 )$$

Given below is an aspherical surface coefficient of the second embodiment of the IR lens in the first aspect of the invention.

| # | K | A | B | C |
|---|---|---|---|---|
| 3 | 11.18 | −2.6157E−07 | 1.3647E−09 | −6.4802E−13 |
| 4 | −133.59 | −1.0171E−06 | 1.3567E−09 | −6.5785E−13 |

Given below is a value of the term f/f1 in the formula (10) for the second embodiment of the IR lens in the first aspect of the invention.

f/f1=0.90734

### 3. The 3rd Embodiment of the IR lens in the 1st Aspect of the Invention

| | |
|---|---|
| Focal Length | 99.97 mm |
| Entire Length of the Optics | 134.23 mm |
| Back Focus | 15.99 mm |
| F-Number | 1.03 |
| Half-Angle of View | 3.16° |
| Image Height | 5.5 mm |

| # | R | d | r | n | f |
|---|---|---|---|---|---|
| 1 | 122.56 | 7.4 | 48.6 | 4.0052 | 118.61 |
| | | | | | (Germanium) |
| 2 | 178.322 | 7.05 | 47.4 | | |
| S | | 45.29 | 47.0 | | |
| 3 | −247.09 | 5.2 | 30.3 | 2.5861 | −278.32 |
| | | | | | (Chalcogenide) |
| 4 | −565.88 | 49.2 | 30.2 | | |
| 5 | 26.1384 | 4.1 | 14.3 | 4.0052 | 67.2485 |
| | | | | | (Germanium) |
| 6 | 26.4879 | 4.0 | 12.6 | | |

# Surface Number
R Radius of Curvature
d Lens Thickness or Distance between the Adjacent Surfaces
r Lens radius
n Refractive Index
f Focal Length
S Aperture Stop

Given below is an aspherical surface coefficient of the third embodiment of the IR lens in the first aspect of the invention:

| # | K | A | B | C |
|---|---|---|---|---|
| 3 | 41.052 | −1.2762E−06 | 9.5458E−10 | −1.1180E−13 |
| 4 | 235.153 | −1.6921E−06 | 1.0090E−09 | −1.9671E−13 |

The surface #4 of the third embodiment of the IR lens in the first aspect of the invention is a diffractive optical element (DOE) surface as expressed by the following DOE formula:

Ø(H)=C1×H²+C2×H⁴+C3×H⁶ (20)

Given below is a DOE coefficient of the surface #4 of the third embodiment of the IR lens in the first aspect of the invention:

| # | C1 | C2 | C3 |
|---|---|---|---|
| 4 | −1.5364E−05 | 1.7070E−09 | 8.6709E−13 |

Given below is a value of the term f/f1 in the formula (10) for the third embodiment of the IR lens in the first aspect of the invention.

f/f1=0.84285

### 4. The 4th Embodiment of the IR lens in the 1st Aspect of the Invention

| | |
|---|---|
| Focal Length | 99.97 mm |
| Entire Length of the Optics | 134.30 mm |
| Back Focus | 16.06 mm |
| F-Number | 1.03 |
| Half-Angle of View | 3.16° |
| Image Height | 5.5 mm |

| # | R | d | r | n | f |
|---|---|---|---|---|---|
| 1 | 122.56 | 7.4 | 48.6 | 4.0052 | 118.61 |
| | | | | | (Germanium) |
| 2 | 178.322 | 7.1 | 47.4 | | |
| 3S | | 45.3 | 47.0 | | |
| 4 | −247.09 | 5.2 | 30.3 | 2.5861 | −279.32 |
| | | | | | (Chalcogenide) |
| 5 | −565.88 | 49.2 | 30.2 | | |
| 6 | 26.1384 | 4.1 | 14.3 | 4.0052 | 67.2485 |
| | | | | | (Germanium) |
| 7 | 26.4879 | 4.0 | 12.6 | | |

# Surface Number
R Radius of Curvature
d Lens Thickness or Distance between the Adjacent Surfaces
r Lens radius
n Refractive Index
f Focal Length
S Aperture Stop

Given below is an aspherical surface coefficient of the fourth embodiment of the IR lens in the first aspect of the invention:

| # | K | A | B | C |
|---|---|---|---|---|
| 3 | 41.092 | −1.2135E−06 | 8.6047E−10 | −6.3565E−14 |
| 4 | 237.001 | −1.6278E−06 | 9.1084E−10 | −1.4261E−13 |

Given below is a value of the term f/f1 in the formula (10) for the fourth embodiment of the IR lens in the first aspect of the invention:

f/f1=0.84285

### 5. The 5th Embodiment of the IR Lens in the 1st Aspect of the Invention

| | |
|---|---|
| Focal Length | 99.91 mm |
| Entire Length of the Optics | 128.90 mm |
| Back Focus | 12.77 mm |
| F-Number | 0.91 |
| Half-Angle of View | 3.14° |
| Image Height | 5.5 mm |

| # | R | d | r | n | f |
|---|---|---|---|---|---|
| 1 | 115.567 | 6.9 | 63.0 | 4.0052 | 102.653 |
| | | | | | (Germanium) |
| 2 | 176.492 | 58.9 | 63.0 | | |
| 3S | | 2.4 | 21.0 | | |
| 4 | −167.43 | 4.91 | 21.5 | 2.5861 | −79.815 |
| | | | | | (Chalcogenide) |
| 5 | 528.426 | 35.3124 | 20.832 | | |
| 6 | 35.2129 | 7.7 | 14.3 | 4.0052 | 40.2048( |
| | | | | | (Germanium) |
| 7 | 41.5215 | 4.0 | 11.9 | | |

# Surface Number
R Radius of Curvature
d Lens Thickness or Distance between the Adjacent Surfaces
r Lens radius
n Refractive Index
f Focal Length
S Aperture Stop

Given below is an aspherical surface coefficient of the fifth embodiment of the IR lens in the first aspect of the invention:

| # | K | A | B | C |
|---|---|---|---|---|
| 3 | 6.589 | 2.5359E−08 | 5.2297E−10 | −1.3297E−13 |
| 4 | −1486.6 | 1.4375E−07 | −3.1084E−10 | 4.1217E−13 |

Given below is a DOE coefficient of the surface #3 of the fifth embodiment of the IR lens in the first aspect of the invention:

| # | C1 | C2 | C3 |
|---|---|---|---|
| 3 | 5.8600E−05 | 1.4624E−07 | −2.1360E−10 |

Given below is a value of the term f/f1 in the formula (10) for the fifth embodiment of the IR lens in the first aspect of the invention:

f/f1=0.97328

### 6. The 1st Embodiment of the IR lens in the 2nd Aspect of the Invention

| Focal Length | 50.0 mm |
|---|---|
| Entire Length of the Optics | 99.21 mm |
| Back Focus | 8.91 mm |
| F-Number | 1.4 |

| # | R | d | r | n | f |
|---|---|---|---|---|---|
| 1 | 50.4506 | 3.5 | 19.9 | 4.0032 | 58.25383 |
| | | | | | (Germanium) |
| 2 | 67.2052 | 15.0 | 19.2 | | |
| 3S | | 50.54 | 13.0 | | |
| 4 | −47.1008 | 6.0 | 9.5 | 4.0032 | −83.2086 |
| | | | | | (Chalcogenide) |
| 5 | −63.5872 | 10.2 | 20.832 | | |
| 6 | 30.5063 | 4.5 | 9.6 | 4.0032 | 30.38597 |
| | | | | | (Germanium) |
| 7 | 40.7545 | 8.91 | 8.6 | | |

# Surface Number
R Radius of Curvature
d Lens Thickness or Distance between the Adjacent Surfaces
r Lens radius
n Refractive Index
f Focal Length
S Aperture Stop

Given below are values of the term |r4|/f in the formula (11), the term (|r4|+d4)/|r5| in the formula (12), the term f1/f in the formula (13), and the term bf/f3 in the formula (14) for the first embodiment of the IR lens in the second aspect of the invention:

|r4|/f=0.942016

(|r4|+d4)/|r5|=0.835086

f1/f=1.165077

bf/f3=0.293227

### 7. The 2nd Embodiment of the IR Lens in the 2nd Aspect of the Invention

| Focal Length | 50.0 mm |
|---|---|
| Entire Length of the Optics | 68.03 mm |
| Back Focus | 8.261 mm |
| F-Number | 1.4 |

| # | R | d | r | n | f |
|---|---|---|---|---|---|
| 1 | 54.344 | 2.8 | 18.2 | 4.0032 | 57.44527 |
| | | | | | (Germanium) |
| 2 | 76.268 | 4.0 | 17.7 | | |
| 3S | | 27.71 | 16.75 | | |
| 4 | −109.423 | 5.0 | 10.9 | 4.0032 | −83.9773 |
| | | | | | (Chalcogenide) |
| 5 | −199.911 | 16.26 | 11.2 | | |
| 6 | 24.6746 | 4.0 | 9.7 | 4.0032 | 30.9991 |
| | | | | | (Germanium) |
| 7 | 29.4899 | 8.26 | 8.6 | | |

# Surface Number
R Radius of Curvature
d Lens Thickness or Distance between the Adjacent Surfaces
r Lens radius
n Refractive Index
f Focal Length
S Aperture Stop

Given below are values of the term |r4|/f in the formula (11), the term (|r4|+d4)/|r5| in the formula (12), the term f1/f in the formula (13), and the term bf/f3 in the formula (14) for the first embodiment of the IR lens in the second aspect of the invention:

|r4|/f=2.188468

(|r4|+d4)/|r5|=0.572373

f1/f=1.148905

bf/f3=0.266459

### 8. The 1st Embodiment of the IR Lens in the 3rd Aspect of the Invention

| Focal Length | 24.98 mm |
|---|---|
| Entire Length of the Optics | 48.046 mm |
| Back Focus | 8.5 mm |
| F-Number | 1.39 |

| # | R | d | r | n | f |
|---|---|---|---|---|---|
| 1 | 66.5086 | 1.9 | 9.49 | 4.003 | 33.7846 |
| | | | | | (Germanium) |
| 2 | 188.947 | 1.724 | 9.26 | | |
| 3S | | 4.0 | 8.4 | | |
| 4 | −17.487 | 5.2 | 8.33 | 4.003 | 1264.47 |
| | | | | | (Chalcogenide) |
| 5 | −21.29 | 22.722 | 10.16 | | |
| 6 | 21.9633 | 4.0 | 9.01 | 4.003 | 31.8575 |
| | | | | | (Germanium) |
| 7 | 24.6132 | 4.0 | 7.86 | | |

# Surface Number
R Radius of Curvature
d Lens Thickness or Distance between the Adjacent Surfaces
r Lens radius
n Refractive Index
f Focal Length
S Aperture Stop

Given below are values of the term d5/f3 in the formula (15), the term f3/f in the formula (16), the term f1/f in the formula (17), and the term bf/f3 in the formula (18) for the first embodiment of the IR lens in the second aspect of the invention:

d5/f3=0.71324

f3/f=1.27532

f1/f=1.35138

bf/f3=0.26681

### 9. The 2nd Embodiment of the IR Lens in the 3rd Aspect of the Invention

| Focal Length | 34.99 mm |
|---|---|
| Entire Length of the Optics | 58.9564 mm |
| Back Focus | 9.25644 mm |
| F-Number | 1.37 |

| # | R | d | r | n | f |
|---|---|---|---|---|---|
| 1 | 52.2813 | 2.5 | 14.02 | 4.003 | 48.6067 |
| | | | | | (Germanium) |
| 2 | 78.5354 | 7.0 | 13.58 | | |
| 3S | | 16.817 | 10.52 | | |
| 4 | −18.526 | 5.0 | 9.46 | 4.003 | 4523.89 |
| | | | | | (Chalcogenide) |
| 5 | −22.246 | 14.383 | 11.31 | | |
| 6 | 24.747 | 4.0 | 9.77 | 4.003 | 30.8599 |
| | | | | | (Germanium) |
| 7 | 29.669 | 4.0 | 8.66 | | |

# Surface Number
R Radius of Curvature
d Lens Thickness or Distance between the Adjacent Surfaces
r Lens radius
n Refractive Index
f Focal Length
S Aperture Stop

Given below are values of the term d5/f3 in the formula (15), the term f3/f in the formula (16), the term f1/f in the formula (17), and the term bf/f3 in the formula (18) for the first embodiment of the IR lens in the second aspect of the invention:

d5/f3=0.46607

f3/f=0.88196

f1/f=1.38879

bf/f3=0.29995

What is claimed is:

1. An infrared lens, comprising three lens groups put in serial order from a position closer to an object, namely, the foremost or first group of lens pieces of positive refractivity, the succeeding or second group of lens pieces of negative refractivity, and the rearmost or third group of lens pieces of positive refractivity, and a substance of the second group of lens pieces having greater dispersive power than that or those of the first and third groups of lens pieces.

2. The infrared lens according to claim 1, wherein the substance of the second group of lens pieces is chalcogenide or zinc selenide.

3. The infrared lens according to claim 1, wherein the first and second groups of lens pieces are made of germanium.

4. The infrared lens according to claim 1, wherein the infrared lens meets requirements as defined in the formulae as follows:
0.8≦f/f1≦1.1 (10)
where f is a focal length of the infrared lens, and f1 is the focal length of the first group of lens pieces.

5. The infrared lens according to claim 1, wherein one of the opposite surfaces of at least one of the lens pieces in any group is aspherical.

6. The infrared lens according to claim 1, wherein one of the opposite surfaces of at least one of the lens pieces in any group is shaped to serve as an aspherical diffraction grating.

7. The infrared lens according to claim 1, wherein the third group of lens pieces are displaced in directions orthogonal to the optical axis so as to compensate for image sway.

8. An infrared lens, comprising three lens groups put in serial order from a position closer to an object, namely, the foremost or first group of lens pieces of positive refractivity, the succeeding or second group of lens pieces of negative refractivity, and the rearmost or third group of lens pieces of positive refractivity.

9. The infrared lens according to claim 8, wherein the first, second, and third groups of lens pieces are made of germanium.

10. The infrared lens according to claim 8, wherein the first to third groups of lens pieces all consists of a single lens piece.

11. The infrared lens according to claim 8, wherein the infrared lens meets a requirement defined in the formula as follows:
0.9<|r4|/f (11)
where f is a focal length of the IR lens, and r4 is a curvature of a front surface of the lens piece closest to an object in the second lens group.

12. The infrared lens according to claim 8, wherein the infrared lens meets requirements defined in the formulae as follows:
0.5<(|r4|+d4)/|r5|<0.86 (12)
where r4 is a curvature of a front surface of the lens piece closest to an object in the second lens group, r5 is a rear surface of the lens piece closest to an imaging plane in the second lens group, and d4 is a thickness of the second lens group.

13. The infrared lens according to claim 8, wherein the infrared lens meets requirements defined in the formulae as follows:
1.0<f1/f<1.5 (13)
where f is a focal length of the infrared lens, and f1 is the focal length of the first group of lens pieces.

14. The infrared lens according to claim 8, wherein the infrared lens meets requirements defined in the formulae as follows:
0.2<bf/f3<0.4 (14)
where bf is a back focus of the IR lens, and f3 is a focal length of the third lens group.

15. The infrared lens according to claim 8, wherein the third group of lens pieces are displaced in directions orthogonal to the optical axis so as to compensate for image sway.

16. An infrared lens, comprising three lens groups put in serial order from a position closer to an object, namely, the foremost or first group of lens pieces of positive refractivity, the succeeding or second group of lens pieces of positive refractivity, and the rearmost or third group of lens pieces of positive refractivity.

17. The infrared lens according to claim 16, wherein the first, second, and third groups of lens pieces are made of germanium.

18. The infrared lens according to claim 16, wherein all the first to third groups of lens pieces consist of a single non-cemented lens.

19. The infrared lens according to claim 16, wherein the infrared lens meets requirements defined in the formulae as follows:
0.4<d5/f3<0.75 (15)
where d5 is a focal length of the second lens group, and f3 is the focal length of the third lens group.

20. The infrared lens according to claim 16, wherein the infrared lens meets requirements defined in the formulae as follows:
0.6<f3/f<1.3 (16)
where f3 is a focal length of the third lens group, and f is the focal length of the IR lens.

21. The infrared lens according to claim 16, wherein the infrared lens meets requirements defined in the formulae as follows:
1.0<f1/f<1.5 (17)
where f1 is a focal length of the first lens group while f is the focal length of the infrared lens.

22. The infrared lens according to claim 16, wherein the infrared lens meets requirements defined in the formulae as follows:
0.2<bf/f3<0.4 (18)
where f3 is a focal length of the third lens group while bf is a back focus of the infrared lens.

23. The infrared lens according to claim 16, wherein the third group of lens pieces are displaced in directions orthogonal to the optical axis so as to compensate for image sway.
